(19) United States
(12) Patent Application Publication
(10) Pub. No.: US 2026/0290072 A1
(43) Pub. Date: Sep. 24, 2026

(54) SYSTEM

(71) Applicant: SoftBank Group Corp., Tokyo (JP)

(72) Inventor: Tao JIANG, Tokyo (JP)

(73) Assignee: SoftBank Group Corp., Tokyo (JP)

(21) Appl. No.: 19/564,221

(22) Filed: Mar. 12, 2026

(30) Foreign Application Priority Data
Mar. 19, 2025 (JP) 2025-044891

(51) Int. Cl. G06V 40/16; G06V 10/764; G06V 10/82; G10L 25/63

(52) U.S. Cl. CPC G06V 40/165; G06V 10/764; G06V 10/82; G10L 25/63

(57) ABSTRACT

A system includes a processor that is configured to capture an image of an object by using a camera of a mobile information terminal and identify the object in the image by using an object recognition algorithm, generate, based on the identified object, a prompt sentence for instructing an appropriate operation with respect to the object, transmit the generated prompt sentence to a server on a cloud and cause a generative artificial intelligence model to generate related information based on the prompt sentence, and receive the generated related information from the server and cause the generated related information to be displayed to a user on a terminal.

### CROSS-REFERENCE TO RELATED APPLICATION

This application is based on and claims priority under 35 USC 119 from Japanese Patent Application No. 2025-044891 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional mobile information terminals allow users to capture images and manually search for information related to objects included in those images. However, such conventional techniques require the user to perform multiple separate operations, such as identifying the object, determining an appropriate subsequent action, inputting keywords, and navigating through various applications or web pages. As a result, the process for obtaining contextually relevant information or services related to a real-world object is time-consuming, complex, and highly dependent on the user's search skills.

Furthermore, conventional systems do not adequately adapt the provided information to the user's current emotional state. Even when related information is retrieved, the information is often presented in a uniform manner, without considering whether the user is confused, hesitant, or highly motivated. This lack of personalization can reduce user satisfaction and may fail to support effective decision-making.

In addition, existing systems generally do not provide a unified mechanism for integrating manual selection of objects in an image with automatic generation of suitable actions by a generative artificial intelligence model. When multiple objects appear in the same image, the user must often repeat the search and selection process for each object, and the system does not efficiently generate prompts or operation instructions that are tailored to the specific object selected by the user.

Accordingly, there is a need for a system that can automatically capture and recognize objects using a camera of a mobile information terminal, generate an appropriate prompt for a generative artificial intelligence model based on the recognized object, obtain and present relevant information or operations, and further optimize such information based on the user's emotional state and manual object selection, thereby improving convenience, efficiency, and personalization in obtaining object-related information and services.

### SUMMARY

In order to solve the above-described problems, a system according to one embodiment of the present invention comprises a processor, wherein the processor is configured to capture an image of an object by using a camera of a mobile information terminal and identify the object in the image by using an object recognition algorithm. The processor is further configured to generate, based on the identified object, a prompt sentence for instructing an appropriate operation with respect to the object, transmit the generated prompt sentence to a server on a cloud, cause a generative artificial intelligence model executed on the server to generate related information based on the prompt sentence, receive the generated related information from the server, and cause the generated related information to be displayed to a user on a terminal. In this manner, the system automatically links real-world object recognition with generative artificial intelligence processing and presentation of relevant information, thereby reducing the number of manual steps required from the user. In a preferred embodiment, the processor is further configured to acquire a facial expression or a voice of the user, perform emotion analysis based on the acquired facial expression or voice, and optimize the related information based on a result of the emotion analysis. By incorporating emotion analysis, the system can adjust the type, amount, and presentation style of the information provided to the user. For example, the system can simplify explanations when the user appears confused or provide more detailed technical information when the user appears engaged and attentive, thereby improving the personalization and usability of the provided information.

In another embodiment, the processor is configured to receive a manual operation from the user for selecting the object and generate the prompt sentence for instructing the operation with respect to the selected object. Specifically, when multiple objects are present in a single image, the user can manually select a particular object on the display, and the processor generates a prompt sentence that explicitly refers to the manually selected object and its context. By combining manual selection with automatic prompt generation for the generative artificial intelligence model, the system can provide object-specific operations and information in a unified framework. As a result, the system enables efficient retrieval and presentation of information tailored both to the object recognized or selected in the image and to the user's emotional state, thereby solving the problems of conventional techniques.

The term “system” refers to an apparatus or combination of apparatuses including at least one processor and, optionally, one or more terminals, cameras, servers, networks, and storage devices configured to execute the functions described in the claims.

The term “processor” refers to any hardware circuitry, such as a central processing unit (CPU), microprocessor, digital signal processor (DSP), graphics processing unit (GPU), system-on-chip (SoC), or combination thereof, that is configured to execute instructions to perform the processing operations described in the claims.

The term “mobile information terminal” refers to a portable electronic device, such as a smartphone, tablet computer, wearable device, or handheld terminal, that includes at least a processor, a display, and a communication interface, and that can execute applications and communicate with external servers over a network.

The term “camera” refers to an image capture device integrated into or connected to the mobile information terminal, configured to capture still images or moving images of a scene including one or more objects.

The term “object recognition algorithm” refers to a software or hardware implemented procedure, including but not limited to machine learning or deep learning models, that processes an image to detect and classify one or more objects contained in the image.

The term “object” refers to any physical item or entity present in a scene that can be captured by the camera and identified by the object recognition algorithm, including but not limited to products, buildings, signboards, persons, or vehicles.

The term “prompt sentence” refers to a text or text-like data structure generated by the processor that describes the identified object and instructs a generative artificial intelligence model to perform a specific operation or generate specific information related to the object.

The term “server” refers to a computing device or a group of computing devices, typically located in a cloud environment, that executes one or more services including at least the generative artificial intelligence model and responds to requests sent from the mobile information terminal.

The term “cloud” refers to a networked computing environment in which computing resources, including servers and storage, are provided over a network such as the Internet and can be accessed remotely by the mobile information terminal.

The term “generative artificial intelligence model” refers to a machine learning model, such as a large language model or multimodal model, that is configured to generate text, data, or other content based on input including the prompt sentence.

The term “related information” refers to information generated by the generative artificial intelligence model in response to the prompt sentence, and may include explanations, recommendations, links, summaries, operational instructions, or other content associated with the identified object.

The term “terminal” refers to the mobile information terminal or another user-side device that displays the related information to the user and optionally acquires user input such as manual operations, facial expressions, or voice.

The term “user” refers to a person who operates the mobile information terminal or terminal, captures images, provides manual input, and views or otherwise consumes the related information displayed by the system.

The term “facial expression” refers to visual information relating to the user's face captured by a camera or sensor, from which an emotional state of the user may be inferred.

The term “voice” refers to audio information, including speech or non-speech sounds, emitted by the user and captured by a microphone or similar audio input device.

The term “emotion analysis” refers to a process that analyzes the user's facial expression and/or voice to estimate an emotional state, such as happiness, sadness, confusion, interest, or stress.

The term “optimize the related information” refers to adjusting the content, amount, style, timing, or presentation of the related information based on the result of the emotion analysis so as to better suit the user's current emotional state or needs.

The term “manual operation” refers to an operation explicitly performed by the user on the terminal, such as tapping, clicking, dragging, or other gesture input on a touch screen or input device, to select an object or issue a command.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### FIRST EXEMPLARY EMBODIMENT

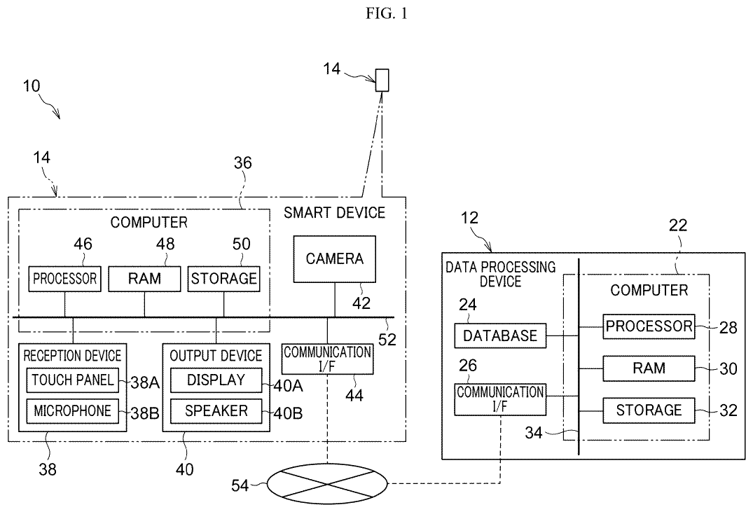

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

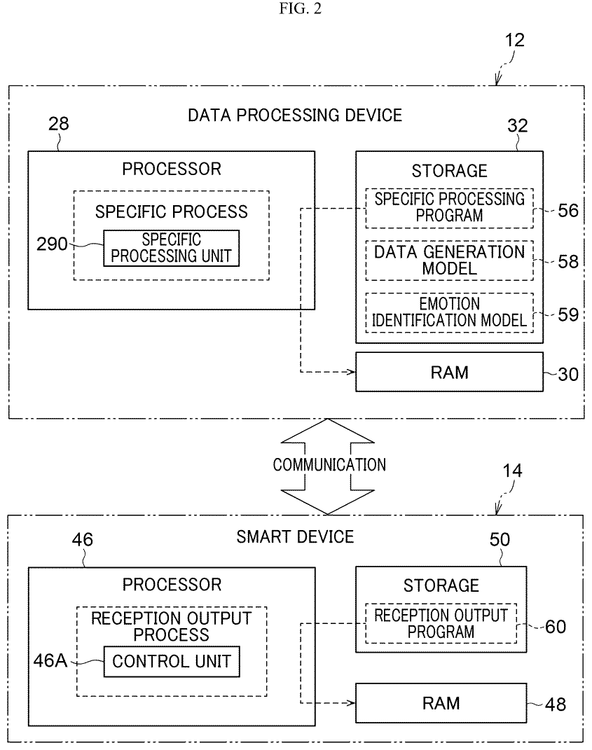

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional image-based information retrieval systems typically apply an image recognition algorithm on a client or a server to identify an object depicted in captured image data and then perform a fixed mapping from an identified object category to pre-defined information, such as a static web page, a fixed list of links, or a generic search query. In such systems, the processing logic is largely rule-based and does not flexibly adapt the selection, structuring, and presentation of information to the specific context of the object instance, user behavior, or historical usage patterns. As a result, the systems often return information that is not optimally relevant or actionable for the user, thereby forcing the user to perform additional manual navigation or search operations.

Furthermore, in many existing architectures, a generative AI model, if used at all, is merely invoked to generate natural language descriptions or summaries, while the control flow for deciding which external services to call, which links to present, and how to prioritize actions remains hard-coded in application logic. This separation leads to duplicated logic between the application layer and the generative AI model, complicates maintenance, and makes it difficult to systematically improve relevance and usability over time. In addition, these systems typically do not log and feed back the relationship between recognized objects, generated content, and user selections into the prompt design or retrieval conditions in a structured, automated manner.

From a computer technology perspective, such limitations translate into suboptimal use of compute resources and network bandwidth: servers generate and transmit large amounts of low-utility data, and terminals render user interfaces that users frequently ignore or bypass. The absence of a closed feedback loop between generative AI outputs and actual user interaction prevents the system from converging toward more efficient, targeted responses, resulting in unnecessary processing, repeated data transmissions, and inefficient utilization of machine learning inference resources.

There is therefore a need for an improved computer-implemented technique that tightly integrates object recognition, structured data construction, prompt sentence generation, and generative AI-based selection of information and actions, and that further incorporates user interaction logs to iteratively refine prompt wording and retrieval conditions. Such a technique should enable a server and a portable information processing device to cooperatively reduce redundant processing, minimize the transmission and rendering of low-utility information, and increase the likelihood that the initially presented actions and information are directly useful to the user. In particular, there is a need for a system-level mechanism that treats the prompt sentence and associated structured data as first-class, dynamically adaptable control signals within the architecture, rather than as static or hand-crafted text, thereby improving the overall efficiency, responsiveness, and relevance of the computer system as a whole.

The specific processing by the specific processing unit 290 of the data processing device 12 in Example 1 is realized by the following means.

The present invention provides a server comprising a processor configured to receive, from a portable information processing device, image data of a target object, feature information of the target object, and a category of the target object that have been derived by an object recognition algorithm and an image feature extraction algorithm, to acquire, based on the feature information and the category, candidate information and candidate actions to be presented for the target object from one or more data storage units or external information resources, to generate structured data including at least the candidate information and the candidate actions, to generate a prompt sentence that describes an analysis result including the structured data, to cause a generative AI model operating on the server or on a remote information processing device to receive the prompt sentence and the structured data and to generate response data including information related to the target object and including one or more actions selected from among the candidate actions, to transmit the response data to the portable information processing device for presentation via a user interface, to receive log information indicating user interaction with the one or more actions included in the response data, and to update at least one of wording of the prompt sentence and a retrieval condition used to acquire the candidate information based on the log information. This enables the computer system to use the generative AI model not merely for text generation but as a dynamic decision-making component that selects and structures information and actions according to object context and empirically observed user behavior, thereby reducing unnecessary data retrieval and transmission, improving the relevance of information initially presented on the portable information processing device, and enhancing overall computational efficiency and responsiveness of the server-client architecture.

The term “portable information processing device” refers to an electronic apparatus that is capable of executing application programs, communicating with a server over a network, and being carried by a user, and that includes at least a processor, a memory, a display unit, and an imaging unit such as a camera.

The term “imaging unit” refers to a hardware component that captures visual information of a scene, such as an image sensor, an optical system, and associated circuitry, and that outputs digital image data representing a target object.

The term “target object” refers to a physical entity, such as a product, facility, place, or other real-world item, that is depicted in captured image data and for which related information or actions are to be provided to a user.

The term “image data” refers to digital data representing visual information captured by the imaging unit, including still images or video frames, and encoded in a predetermined format.

The term “object recognition algorithm” refers to a software-implemented processing procedure that analyzes image data to detect and classify one or more objects contained in the image data, and that outputs, for example, a category or location of each detected object.

The term “image feature extraction algorithm” refers to a software-implemented processing procedure that converts image data, or a region thereof, into numerical or symbolic feature information representing visual characteristics such as shapes, colors, textures, or patterns.

The term “feature information” refers to data derived from image data by the image feature extraction algorithm, including numerical feature vectors, descriptors, or other representations that characterize the appearance of the target object.

The term “category of the target object” refers to a classification label or type information assigned to the target object by the object recognition algorithm, indicating, for example, that the target object belongs to a particular class such as a product, a facility, a restaurant, or an article of clothing.

The term “candidate information” refers to one or more pieces of data relating to the target object that are obtained from a data storage unit or an external information resource and that are eligible to be presented to a user, such as descriptive information, evaluation information, or link information.

The term “candidate actions” refers to one or more possible operations associated with the target object that can be invoked by a user, including, for example, accessing a purchase page, opening a review page, or initiating a reservation process.

The term “structured data” refers to data organized according to a predetermined schema or format, such as a record, an object, or a hierarchical data structure, and including at least the candidate information and the candidate actions associated with the target object.

The term “prompt sentence” refers to a text sequence, including natural language expressions and optionally embedded structured data, that is supplied as input to a generative AI model to instruct or constrain processing by the generative AI model in generating response data.

The term “generative AI model” refers to a trained machine learning model that generates output data, such as text or structured information, in response to input data including at least a prompt sentence, and that is capable of selecting or composing information and actions according to the prompt sentence.

The term “remote information processing device” refers to a computing apparatus that is separate from the portable information processing device and that is connected via a communication network, and that executes at least a part of processing including execution of the generative AI model.

The term “response data” refers to data generated by the generative AI model based on the prompt sentence and the structured data, and including at least information related to the target object and one or more actions selected from among the candidate actions.

The term “display data” refers to data formatted for presentation on a user interface of the portable information processing device, and derived at least in part from the response data.

The term “operation component” refers to a user interface element displayed on the portable information processing device, such as a button, icon, or selectable region, that corresponds to an action and that accepts a selection operation from a user.

The term “external service” refers to a network-accessible function or system, including, for example, a reservation system, an electronic commerce system, or an information providing system, that is operated by an entity different from the portable information processing device and the server.

The term “information resource” refers to a data source accessible via a communication network, such as a web page, a database entry, or an application programming interface endpoint, that provides information related to the target object.

The term “log data” refers to recorded data representing a history of operations and results in the system, including at least the response data, the category of the target object, and a selection result by the user regarding one or more actions.

The term “selection result” refers to information indicating which action or actions included in the response data were selected or not selected by the user through interaction with the operation components.

The term “retrieval condition” refers to a parameter, rule, or criterion used for acquiring the candidate information or candidate actions from a data storage unit or an external information resource, such as a filter condition, a ranking condition, or a query parameter.

The term “facial information” refers to data representing an image or characteristic of a user's face obtained from a sensor, including at least a region of image data in which the user's face appears and feature values derived therefrom.

The term “voice information” refers to audio data representing a sound signal of a user's voice and feature information derived from the audio data, such as spectral features, pitch information, or prosodic patterns.

The term “emotion analysis processing” refers to processing that estimates an emotional state of a user by analyzing facial information or voice information using a statistical model, a machine learning model, or a rule-based algorithm.

The term “emotional state” refers to information indicating a user's inferred affective condition, such as satisfaction, interest, displeasure, or confusion, resulting from the emotion analysis processing.

The term “user interface” refers to a presentation and input mechanism provided by the portable information processing device, including a display, a touch panel, buttons, or other input/output means, through which a user views information and performs operations.

The term “designation operation” refers to an input action by which a user specifies a region or object in the image data, for example by touching, dragging, or otherwise indicating a position or area on the display of the portable information processing device.

In one embodiment, a server cooperates with a terminal to implement a system that provides context-aware information and actions related to a target object captured in image data. The terminal is realized as a portable information processing device such as a smartphone or tablet. The server is realized as one or more computing devices, for example one or more physical servers or virtual machines executing an operating system and application software. The server and the terminal communicate via a communication network such as a wireless network and a packet-switched data network.

The terminal includes an imaging unit, a display, a touch-sensitive input interface, a local processor, a memory, and a network interface. The terminal uses a camera framework, such as a camera control library provided by a mobile operating system (for example, a framework similar to CameraX or a framework similar to AVFoundation), to control a solid-state image sensor and associated optics. The terminal obtains raw pixel data, converts the pixel data to image data in a compressed format, such as a JPEG format or a PNG format, and stores the image data in a local storage subsystem implemented by a flash memory and a file system. The terminal analyzes the image data to derive at least coarse feature information and category information for a target object. The terminal can include a lightweight feature extraction module implemented, for example, by a convolutional neural network having a small number of layers or by a mobile-optimized network architecture. The terminal converts the image data to a tensor representation stored in a memory and executes convolution, pooling, and normalization operations on a processor or on a graphics processing unit built into the terminal. The terminal outputs intermediate feature information and a preliminary category label for the target object. The terminal then constructs a message that includes the image data, the feature information, and the preliminary category label, and transmits the message to the server by using a network library, such as a library similar to an HTTP client or a socket interface, over a transport protocol such as TCP/IP with encryption.

The server receives the image data and the associated information from the terminal through a web application framework. The server parses headers and payloads and stores the received image data temporarily in a non-volatile storage device such as a solid-state drive. The server also stores the accompanying feature information and category label in a memory as structured records.

The server further refines object recognition and feature extraction by using a more complex image analysis module implemented by a deep neural network. In one embodiment, the server uses a convolutional neural network or a vision transformer model implemented in a numerical computation framework such as a tensor-based computation library. The server loads the image data into a numerical tensor, normalizes pixel values according to predetermined mean and standard deviation parameters, and resizes the image data to a fixed resolution, such as 224 by 224 pixels or 384 by 384 pixels. The server then propagates the tensor through a plurality of layers, each layer performing linear transformations, nonlinear activation functions, and normalization operations. The server obtains a high-dimensional feature vector representing global characteristics of the target object and, in some cases, spatial feature maps or attention maps representing local characteristics.

The server can additionally apply an object detection module to locate candidate objects within the image. The server may use an object detection network, such as an architecture having region proposal mechanisms and classification heads. The server computes, for a plurality of bounding boxes, confidence scores for object presence and probability distributions over categories. The server selects, as the target object, a bounding box having a maximum confidence score or a bounding box satisfying other predetermined criteria. The server associates the bounding box coordinates with corresponding region features extracted from the feature maps.

The server further extracts feature information such as color histograms, texture descriptors, and text content. For text content, the server employs an optical character recognition engine implemented by a pattern recognition algorithm that segments image regions into candidate text regions, classifies glyphs, and outputs character sequences. The server associates detected text with the target object, for example by determining overlap between text regions and the bounding box of the target object.

The server aggregates the above-described information into structured data. The server represents the structured data as, for example, a record having fields for a category label, feature vectors, bounding box coordinates, and detected text. The server may additionally include references to database identifiers, similarity scores to known items, and rankings of relevance for different candidate information sources. The server stores the structured data in a working memory in a format suitable for later access, such as a key-value structure or a hierarchical object representation.

The server then acquires candidate information and candidate actions for the target object. In one embodiment, the server queries an internal data store implemented by a database management system. The server uses the category label and feature information as query conditions. For example, when the category label indicates that the target object is an article of clothing, the server forms a query including color features, style descriptors, and detected brand text, and sends the query to the database. The database returns candidate product records having fields such as product titles, descriptions, prices, ratings, and external links. When the category label indicates that the target object is a facility such as a restaurant, the server constructs a query including detected text that likely represents a store name and a geographic region inferred from location information, and sends the query to another data store. The data store returns candidate facility records including menu information, rating values, and reservation links.

The server constructs candidate actions based on the category and the available information sources. For example, when the target object is a product, the candidate actions may include actions such as viewing a detailed information page, viewing user reviews, and accessing a purchasing interface. When the target object is a restaurant, the candidate actions may include actions such as viewing a menu, accessing a map for navigation, and initiating a reservation procedure. The server writes these candidate actions into the structured data as action entries, each entry having at least a label, a type identifier, and a link or parameter set.

The server then generates a prompt sentence for a generative AI model. The server treats the prompt sentence as a control element that instructs the generative AI model how to prioritize and format information. In one embodiment, the server constructs the prompt sentence by concatenating static instruction text with dynamically generated segments based on the structured data. The server can include, in the prompt sentence, the category label, the detected text, and a textual representation of the candidate information. The server may use a template, such as:

“Analyze the following detected object and candidate data, and choose the most useful information to show to a smartphone user. Detected category: [category]. Detected text: [text]. Candidate data: [summarized candidate information]. Please select actions and summarize concisely for the user.”

In another embodiment, the server uses a more specialized prompt sentence for a specific category. For example, when the category is a restaurant, the server may use a prompt sentence such as:

“Detected object: restaurant. Detected text: ‘[restaurant name]’. Candidate data: average rating [value], price range [symbol], menu items [list], reservation URL [link], review URL [link]. Please generate a concise summary for a smartphone user and choose up to three main actions (e.g., ‘View Menu’, ‘See Reviews’, ‘Reserve a Table’). Return a structured response describing the title, summary, main actions, and optional details.”

When the category is clothing, the server may use a prompt sentence such as: “Detected object: clothing (T-shirt). Attributes: color=[color], style=[style], brand text detected: ‘[brand text]’. Candidate products with prices and links are provided below. Please select the best matching item and summarize it for a user viewing this on a smartphone. Include purchase link, price, key features, and a short rating summary.”

The server passes the prompt sentence, together with the structured data, to a generative AI model. In one embodiment, the generative AI model is implemented as a large-scale neural network having a transformer architecture with attention layers, feed-forward layers, and embedding layers. The server encodes the prompt sentence into token sequences and passes the tokens, along with encoded representations of the structured data, into the generative AI model. The server executes the generative AI model on hardware that may include one or more graphics processing units or tensor processing units. The server performs operations such as matrix multiplications, softmax operations, layer normalizations, and nonlinear activations according to parameters learned during a prior training phase.

In the training phase, a training system provides the generative AI model with training pairs of input prompt sentences and desired output responses. The training system defines an objective function, such as a cross-entropy loss between predicted token distributions and target token distributions. The training system performs forward passes and backward passes through the network to compute gradients of the objective function with respect to network weights. The training system updates the weights according to an optimization algorithm, such as stochastic gradient descent or an adaptive optimization algorithm. The training system can also apply data augmentation strategies to prompt sentences and candidate data to improve robustness, including perturbing word order, injecting noise into feature representations, and varying the number and type of candidate actions.

In some embodiments, the server further fine-tunes the generative AI model or adjusts prompt sentence templates using log data. The server stores, for each interaction, information about the prompt sentence used, the response generated by the generative AI model, and which actions the user selected. The server analyzes these logs to compute statistics, such as selection rates for different action types and differences in performance between alternate prompt templates. The server modifies future prompt sentences by adjusting wording, ordering of candidate actions, or emphasis on certain attributes, based on these statistics. Because the server uses this feedback to modify machine-executable control signals (prompt sentences and retrieval conditions), the system continually improves both selection accuracy and computational efficiency. The system thereby reduces the need to transmit unnecessary candidate information to the terminal and reduces the average length of responses, which reduces network bandwidth consumption.

The server receives output tokens from the generative AI model and decodes the tokens into a text response or a structured textual representation. The server parses the response to identify fields such as a title, a summary, and a list of actions selected from the candidate actions. The server performs consistency checks, such as ensuring that selected actions refer only to actions present in the structured data and that required fields are present. If the generative AI model suggests new actions not present in the candidate set, the server may reject or remap such actions to known types to avoid inconsistent behavior.

The server enriches the generative AI model output with concrete identifiers and links. For example, if the generative AI model selects a “Reserve a Table” action, the server associates this action with a reservation endpoint URL and parameters needed by a reservation system. The server inserts identifiers of records in the internal database, query parameters for application programming interfaces, and other low-level data necessary for subsequent processing. The server then formats this enriched response as a compact data structure and transmits it to the terminal.

The terminal receives the enriched response data and uses a user interface framework to render the information. The terminal creates user interface elements such as text fields, image thumbnails, and interactive buttons on the display. The terminal maps each button to a specific action entry supplied by the server. When the user touches or otherwise selects a button, the terminal triggers a corresponding network request or launches a system component, such as a web viewer or a map application, thereby controlling other hardware and software components.

The system yields technical effects beyond simple automation of human decision making. By integrating deep feature extraction, candidate generation, and generative AI-based selection into a unified loop that uses feedback from user behavior, the server reduces redundant computation and network traffic. The server no longer sends all candidate information to the terminal, but instead relies on the generative AI model to perform a prioritized selection. As a result, the average size of response messages is reduced, which decreases transmission time and energy consumption on both the server and the terminal. Furthermore, by using high-dimensional feature vectors and similarity computations instead of purely rule-based category matching, the server increases precision of object identification, which reduces the number of incorrect or irrelevant actions presented to the user.

The system also improves computational efficiency in the server by structuring processing around the prompt sentence. The server uses the prompt sentence as a compact representation of the decision context, allowing the server to decompose decision logic from fixed program code and to delegate complex prioritization to the generative AI model. This reduces the amount of fixed conditional branching in application code and allows the server to update decision behavior without redeploying code, but by updating prompt sentence templates and retrieved candidate sets. The server can therefore react to changing patterns in user behavior more quickly, which leads to better alignment between computational resources and actual user needs.

In some embodiments, the server uses a modular architecture in which a first module performs image feature extraction, a second module performs candidate retrieval from databases or external systems, and a third module implements the generative AI model interface. The server passes structured data among these modules via predefined schemas. This modular configuration allows scaling different parts of the system independently, for example scaling the generative AI model on specialized accelerators while maintaining the image processing and data retrieval on more general-purpose hardware.

The system can be applied to multiple usage scenarios. In one scenario, the user points the terminal at a storefront of a restaurant and captures an image. The terminal sends the image and preliminary information to the server. The server detects that the target object is a restaurant and retrieves candidate information such as average rating and reservation links. The server then generates a restaurant-specific prompt sentence as described above, sends the prompt sentence and structured data to the generative AI model, and obtains a response emphasizing menu highlights, an overall rating, and a reservation action. The terminal displays these elements in a compact view. The user selects “Reserve a Table,” and the terminal, guided by data from the server, communicates with a reservation system to complete the reservation. Compared with a conventional system that would show a generic search result page, the system avoids unnecessary rendering of multiple irrelevant links, reduces the number of user interactions, and lowers computation and communication overhead. In another scenario, the user captures an image of a clothing item displayed in a store. The server matches the target object to a set of similar products, constructs candidate actions including a detailed view and purchase interfaces, and generates a clothing-specific prompt sentence. The generative AI model selects the most relevant product representation and summarizes key features and price information. As a result, the terminal displays a concise set of actions and information, which can be directly acted upon by the user. The server logs the user's selection, and future prompt sentences are adjusted to emphasize features that historically led to higher selection rates, such as fit information or material composition, thereby improving relevance and reducing the need to show long lists of alternatives.

In a further embodiment, the server incorporates emotion analysis into the prompt sentence generation. The terminal acquires facial information or voice information from sensors such as cameras or microphones and sends derived emotion features to the server. The server executes an emotion analysis algorithm, which may be implemented by a classification neural network trained on labeled emotion data. The server estimates an emotional state and appends a description of this state to the prompt sentence or embeds it into the structured data. The generative AI model then uses this additional context to select actions and format summaries that better fit the user's inferred emotional state, for example simplifying explanations when confusion is detected or presenting more options when interest is inferred. This context-aware adaptation further improves user satisfaction and reduces repeated queries.

Because the processing performed by the server and the terminal comprises concrete operations on image sensors, processors, memories, communication interfaces, and trained neural network parameters, the system is more than an abstract idea. The system specifies how image data are acquired, transformed into feature representations, structured as candidate information and actions, converted into a prompt sentence, and then used by a generative AI model whose training and operation are concretely described. The system specifies how the results are used to control display components and network interfaces of the terminal in specific, non-conventional ways, leading to improvements in processing efficiency, accuracy of object recognition and information selection, and reduction of communication overhead.

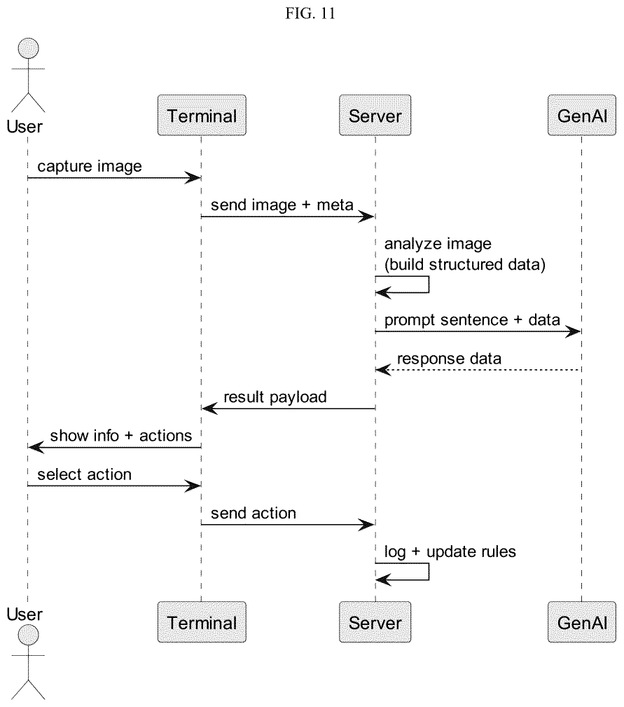

The following describes the processing flow using FIG. 11.

### Step 1:

The user operates the terminal to capture an image of a target object. The user points the imaging unit of the terminal toward the physical object, adjusts focus and framing using on-screen controls, and presses a shutter button displayed on the touch screen. The input of this step is the optical scene including the target object. The terminal converts light received by the image sensor into raw pixel values, performs analog-to-digital conversion, and outputs image data, for example in a JPEG or PNG format, stored in a local memory.

### Step 2:

The terminal preprocesses the captured image data and generates a compact feature representation and a preliminary category for the target object. The input of this step is the image data generated in Step 1. The terminal loads the image data into memory, resizes the image to a fixed resolution, normalizes pixel intensities, and forms a tensor of shape corresponding to channels, height, and width. The terminal applies a lightweight convolutional neural network to the tensor, executing convolution, pooling, and activation operations using its processor or integrated graphics unit. The terminal outputs feature information (for example, a feature vector) and a preliminary category label associated with the target object.

### Step 3:

The terminal constructs and transmits a request message including the image data and the preliminary analysis results to the server. The input of this step is the image data, the feature information, and the preliminary category label from Step 2. The terminal encapsulates these data into a request structure, for example by encoding the image data as binary content and the feature information and category as structured fields. The terminal uses a network library to establish a secure channel and sends the request to a predetermined server endpoint. The output of this step is a network message that is transmitted over a communication network toward the server.

### Step 4:

The server receives and stores the request from the terminal. The input of this step is the network message sent in Step 3. The server uses a communication interface and a web application framework to parse protocol headers, extract the image data, the feature information, and the preliminary category label, and allocate memory buffers to hold these elements. The server writes the image data to a non-volatile storage device with an associated identifier and stores the feature information and category label in a working memory structure. The output of this step is a set of server-internal data structures referencing the received image and its associated metadata.

### Step 5:

The server performs high-precision feature extraction and object recognition on the received image data. The input of this step is the stored image data and the preliminary category label from Step 4. The server loads the image from storage into a tensor-based computation framework, resizes and normalizes the pixel values to match the input specification of a deep neural network, and executes a vision backbone model, such as a convolutional neural network or a vision transformer. The server performs matrix multiplications, nonlinear activations, and normalization operations on dedicated processing hardware, such as a graphics processing unit. The server outputs refined feature information, including a high-dimensional feature vector, updated category probabilities, and, where applicable, object bounding box coordinates.

### Step 6:

The server determines a target object region and aggregates auxiliary features such as text. The input of this step is the refined feature information and bounding box candidates from Step 5. The server selects a bounding box based on criteria such as maximum confidence score or largest area and designates this region as the target object region. The server crops the image according to the bounding box and applies an optical character recognition engine to the cropped region, segmenting text areas and classifying character patterns to obtain detected text strings. The output of this step is a combined representation including a final category label, the selected bounding box, refined feature vectors, and detected text associated with the target object.

### Step 7:

The server constructs structured data describing the target object and retrieves candidate information from one or more data stores. The input of this step is the combined representation from Step 6. The server forms a structured record with fields for category label, feature vectors, bounding box, and detected text, and then uses these fields as query parameters to databases or external information sources. The server computes similarity scores between the feature vector and stored feature vectors, applies filtering conditions based on category and text, and retrieves candidate records such as product entries or facility entries. The server writes the retrieved candidate information, together with potential actions (for example, viewing detail pages or initiating reservations), into the structured record. The output of this step is structured data that includes candidate information and candidate actions for the target object.

### Step 8:

The server generates a prompt sentence for a generative AI model using the structured data. The input of this step is the structured data from Step 7. The server selects a prompt template based on the category label and inserts dynamic values such as detected text, key attributes, and a summary of candidate information into the template. The server performs string concatenation and formatting operations to build a natural-language prompt sentence describing the analysis result and the available candidate actions. For example, for a restaurant, the server may form a prompt sentence such as: “Detected object: restaurant. Detected text: ‘Bistro Sakura’. Candidate data: average rating 4.3/5, price range $$, menu items (pasta, steak, salad), reservation URL [link], review URL [link]. Please generate a concise summary for a smartphone user and choose up to three main actions (e.g., ‘View Menu’, ‘See Reviews’, ‘Reserve a Table’).” The output of this step is a prompt sentence associated with the structured data.

### Step 9:

The server provides the prompt sentence and structured data to the generative AI model and obtains response data. The input of this step is the prompt sentence and the structured data from Step 8. The server tokenizes the prompt sentence, encodes tokens into numerical embeddings, and, if applicable, converts parts of the structured data into textual or embedded form. The server feeds these embeddings into a generative AI model implemented as a neural network with attention layers and feed-forward layers, executing the model on a processing unit. The model computes attention weights, updates hidden states across layers, and outputs probability distributions over possible next tokens, which the server samples or decodes to generate a text response that may describe selected actions and summaries. The output of this step is response data that specifies information related to the target object and selected actions from among the candidate actions.

### Step 10:

The server validates and enriches the response data and prepares a terminal-facing payload. The input of this step is the response data generated in Step 9. The server parses the response to identify sections such as a title, a summary, and a list of actions. The server checks whether each referenced action matches an action in the structured data; if an inconsistency is detected, the server either removes the inconsistent entry or maps it to the closest valid action. The server then attaches concrete identifiers, such as database record IDs and network addresses, to the selected actions, and may append additional metadata such as thumbnail image references or price ranges. The output of this step is a compact payload containing validated information and enriched action specifications ready to be sent to the terminal.

### Step 11:

The server transmits the payload to the terminal. The input of this step is the compact payload from Step 10. The server serializes the payload into a data format such as a structured text or binary format, sets appropriate protocol headers, and sends the payload over the communication network using a server-side communication library. The output of this step is a network response message containing the payload, which is delivered to the terminal.

### Step 12:

The terminal receives and parses the payload from the server. The input of this step is the network response message sent in Step 11. The terminal uses its network interface and protocol stack to accept the message, confirms the integrity and status of the response, and extracts the payload from the message body. The terminal then parses the payload into internal data structures, separating fields such as title, summary text, and action entries. The output of this step is a set of terminal-side data objects representing the information and actions to be displayed.

### Step 13:

The terminal renders the information and operation components on a user interface. The input of this step is the set of terminal-side data objects from Step 12. The terminal uses a user interface framework to create visual components, such as text labels for the title and summary, icon or image views for thumbnails, and interactive buttons or touch areas for each action. The terminal calculates layout positions, applies styling parameters, and draws the components on the display. The terminal associates each button with an action entry so that a later user interaction can be mapped to a specific action. The output of this step is a displayed screen that presents the target object information and selectable operation components to the user.

### Step 14:

The user selects an action from the displayed operation components. The input of this step is the displayed screen from Step 13. The user touches, clicks, or otherwise manipulates an operation component, such as a button labeled “Reserve a Table” or “Buy Now.” The terminal detects this interaction via input hardware such as a touch sensor, converts the event into an input event structure, and identifies which action entry is associated with the operated component. The output of this step is an action selection event indicating the action chosen by the user.

### Step 15:

The terminal executes communication processing corresponding to the selected action. The input of this step is the action selection event from Step 14. The terminal reads the associated action entry, extracts parameters such as a network address and request type, and, depending on the action type, either opens an embedded viewer or initiates a network request. For example, for a reservation action, the terminal may send a structured request to a reservation system endpoint; for a product purchase action, the terminal may open a web viewer and load a purchase page URL. The terminal uses its network interface and relevant application modules to process the action. The output of this step is a follow-up interaction with an external service or information resource.

### Step 16:

The server logs interaction data to improve future processing. The input of this step is information indicating which action the user selected, which prompt sentence and structured data were used, and what response data were generated earlier. The server records these elements in a log storage, associating each record with timestamps, identifiers of the target object, and context information. The server may periodically analyze these logs, computing selection frequencies and performance metrics. The output of this step is updated log data that can be used to refine retrieval conditions and prompt sentence templates in subsequent executions of the system.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional in-store product information systems and mobile shopping assistants rely primarily on static databases and predefined user interface flows. When a user captures an image of a product with a mobile device, typical systems perform simple barcode lookup or keyword matching and then retrieve fixed records from catalog or inventory databases. Such systems face multiple technical limitations.

First, existing systems are not able to flexibly interpret diverse visual inputs and user contexts. Image recognition may identify a product, but the subsequent information generation is constrained to rigid templates and pre-authored text. As a result, the system cannot dynamically adjust the content or level of detail of the presented information based on the specific product attributes, user intent inferred from the captured image, or the user's emotional state. This often leads to overloading the user with irrelevant information or omitting contextually important information, thereby degrading the usability and effectiveness of the human-computer interaction.

Second, the integration between unstructured, natural-language information and structured business data (such as product master data, real-time inventory, and promotion data) is typically performed through bespoke application logic that is not scalable or adaptable. Conventional systems either present raw generative outputs without verifying consistency with structured data, or they ignore the generative capabilities altogether and only show database records. In both cases, there is no robust mechanism to automatically reconcile and refine the generative output using structured records, which can cause inconsistencies, outdated information, or fragmented user experiences.

Third, existing architectures generally treat the mobile device, the server-side recognition, and any external generative model as loosely coupled components without a systematic protocol for generating and controlling prompt sentences. Prompt texts, if used, are often manually specified, not automatically derived from recognized product attributes, and not optimized for stable machine-understandable queries. This lack of a structured prompt-generation pipeline leads to inefficiencies, unpredictable responses from generative models, and difficulty in ensuring that the responses are suitable for real-time, on-device display in a retail environment.

Fourth, existing systems do not sufficiently leverage user multimodal signals, such as facial expressions or voice characteristics, to adapt the behavior of the system at the technical level. Emotion analysis, if used at all, is typically applied as a superficial user experience layer, rather than as a core control signal that dynamically modifies the content selection, prioritization, and level of detail of the information generated and presented. As a consequence, the underlying information processing pipeline cannot efficiently allocate computational and network resources to generate the most relevant content for the current user state and context.

Accordingly, there is a need for a technically improved system that: (i) automatically constructs precise and context-aware prompt sentences from recognition results of captured product images; (ii) utilizes a generative AI model in conjunction with structured databases in a controlled manner; (iii) programmatically reconciles and integrates generative outputs with authoritative structured data; and (iv) dynamically adapts information generation and presentation, including the content and granularity, based on multimodal user state information and user selection of product regions. Such a system should improve the efficiency, reliability, and responsiveness of computer-based in-store information delivery, thereby constituting an improvement in computer technology itself, not merely an automation of human sales assistance.

The specific processing by the specific processing unit 290 of the data processing device 12 in Application Example 1 is realized by the following means.

The present invention provides a server comprising at least one processor and at least one memory storing instructions that, when executed by the at least one processor, cause the server to receive image data of a target captured by a portable information processing apparatus, perform image recognition processing on the image data to determine whether the target corresponds to a merchandise item and to generate target information including at least a merchandise category, a merchandise attribute, and identification information when the target corresponds to the merchandise item, construct, on the basis of the target information, a structured prompt sentence for a generative information processing model, the prompt sentence specifying information items and an expression style so as to define an inquiry content for acquiring at least one of a merchandise description, evaluation information, price information, inventory information, and sales promotion information, transmit the prompt sentence via a network to an information processing apparatus on which the generative information processing model operates, obtain, from the generative information processing model, related information in natural language generated in response to the prompt sentence, associate the related information with structured data stored in at least one of a merchandise information storage unit, an inventory information storage unit, and a sales promotion information storage unit, generate integrated information by supplementing or correcting the related information using the structured data based on predefined reconciliation rules, and transmit the integrated information to the portable information processing apparatus for display as at least one of a merchandise description, an evaluation summary, a price comparison, an inventory status, and sales promotion content. This enables a computer-implemented pipeline in which prompt sentence generation, generative AI output, and structured database information are tightly coordinated to dynamically produce consistent, context-aware, and user-adaptive product information, thereby improving the technical operation of the image recognition, natural language generation, and data integration components in a network-based in-store information system.

The term “system” refers to a combination of hardware and software components that cooperate to perform image capture, data processing, communication, and information presentation functions as claimed.

The term “processor” refers to one or more hardware processing units, such as a central processing unit or a graphics processing unit, capable of executing program instructions to perform arithmetic, logical, control, and input/output operations.

The term “portable information processing apparatus” refers to a handheld or mobile electronic apparatus, such as a smartphone or tablet device, that includes at least a processor, a memory, a display, an input interface, and a communication interface.

The term “imaging unit” refers to a hardware component, such as a camera module including an image sensor and optics, that captures light from a scene and generates corresponding image signals or image data.

The term “image” refers to digital data representing visual information of a scene or target captured by the imaging unit in a two-dimensional format.

The term “target” refers to any physical object, item, or region in the real world that is included in the captured image and is subject to recognition or selection processing by the system.

The term “image data” refers to digital data representing a captured image, including at least pixel values and, optionally, metadata such as capture time, location, or device information.

The term “image recognition processing” refers to a computational process that analyzes image data using algorithms or models, such as pattern recognition, object detection, or classification algorithms, to identify or classify one or more targets depicted in the image.

The term “merchandise item” refers to any product, good, or service that is available for purchase by a consumer in a retail environment.

The term “target information” refers to structured information generated by image recognition processing, including at least one of a merchandise category, a merchandise attribute, and identification information related to a recognized target.

The term “merchandise category” refers to a classification label that indicates a general type or class of a merchandise item, such as a beverage, cosmetic, electronic device, or similar classification.

The term “merchandise attribute” refers to a descriptive characteristic of a merchandise item, such as a brand, model, type, size, capacity, composition, or other distinguishing feature.

The term “identification information” refers to information that uniquely or semi-uniquely identifies a merchandise item, such as a product code, barcode, serial number, or other identifier.

The term “prompt sentence” refers to a textual input sequence, formulated in natural language or a machine-readable format, that is provided to a generative information processing model to request generation of related information.

The term “generative information processing model” refers to a trained computational model, such as a neural network-based generative AI model, configured to generate new information, including natural language text, based on input data such as a prompt sentence.

The term “information items” refers to specific categories or fields of information, such as product description, evaluation information, price information, inventory information, and sales promotion information, that are requested or controlled within a prompt sentence.

The term “expression style” refers to formatting or stylistic parameters of generated text, such as language, tone, level of detail, or structure, as specified or implied by a prompt sentence.

The term “inquiry content” refers to a semantically defined request, encapsulated in a prompt sentence, that specifies what type of information is to be generated or retrieved by the generative information processing model.

The term “network” refers to a communication infrastructure, such as a wireless or wired data network, enabling data exchange between the portable information processing apparatus, the server, and the information processing apparatus executing the generative information processing model.

The term “information processing apparatus” refers to any computing apparatus, such as a server or cloud computing resource, that includes at least one processor and memory and is capable of executing software to process data.

The term “related information” refers to information in natural language or structured form that is generated by the generative information processing model in response to a prompt sentence and that pertains to a merchandise item or target.

The term “natural language” refers to a human language, such as English or another spoken language, used to express information in a form readable and understandable by human users.

The term “structured data” refers to data organized according to a predefined schema or format, such as records in a database table or key-value pairs, enabling deterministic access and processing by computer programs.

The term “merchandise information storage unit” refers to a logical or physical storage component, such as a database or memory region, that stores structured information about merchandise items, including attributes and identifiers.

The term “inventory information storage unit” refers to a logical or physical storage component that stores structured information related to stock levels, availability, or inventory status of merchandise items at one or more locations.

The term “sales promotion information storage unit” refers to a logical or physical storage component that stores structured information about promotional activities, such as discounts, campaigns, coupons, or bundled offers associated with merchandise items.

The term “integrated information” refers to information generated by combining, supplementing, or correcting related information from a generative information processing model with structured data from one or more storage units, according to predetermined rules.

The term “reconciliation rules” refers to predefined conditions or procedures specifying how to align, prioritize, supplement, correct, or merge generative outputs with structured data to form integrated information.

The term “merchandise description” refers to text or data that describes a merchandise item, including at least one of features, specifications, usage, origin, or other descriptive content.

The term “evaluation information” refers to information representing assessments or opinions regarding a merchandise item, including, for example, user reviews, expert ratings, or summary scores.

The term “price information” refers to information indicating a monetary cost associated with a merchandise item, including at least one of a current price, a typical price range, or historical price data.

The term “inventory information” refers to information indicating stock status or quantity of a merchandise item at one or more locations or storage sites.

The term “sales promotion information” refers to information indicating promotional actions related to a merchandise item, including discounts, limited-time offers, bundled sales, or loyalty benefits.

The term “price comparison” refers to information that compares prices of a merchandise item across different stores, channels, or offers.

The term “inventory status” refers to an indicator derived from inventory information that shows whether a merchandise item is in stock, low in stock, or out of stock at a particular location.

The term “sales promotion content” refers to human-readable text or graphical information that presents sales promotion information to a user.

The term “physical store” refers to a brick-and-mortar retail facility where consumers can physically visit to view and purchase merchandise items.

The term “expression information” refers to image or video data, or processed data derived therefrom, representing a user's facial expression or other visual cues that can be analyzed to infer an emotional state.

The term “voice information” refers to audio data, or processed data derived therefrom, representing a user's speech, tone, or vocal characteristics that can be analyzed to infer an emotional state.

The term “emotion analysis processing” refers to a computational process that analyzes expression information or voice information to estimate or classify a user's emotional state.

The term “presentation content” refers to the specific elements of integrated information selected for display to a user, including which fields, texts, or graphical items are shown.

The term “presentation order” refers to the sequence or layout in which presentation content is arranged and displayed to a user on a screen.

The term “level of detail” refers to a degree of granularity or completeness of the information displayed, including, for example, concise summaries or more extensive explanations.

The term “selection operation” refers to user input, such as tapping, clicking, dragging, or other pointing gestures, that indicates a specific region or object in the captured image.

The term “target region” refers to a spatial area within a captured image that is designated by the system or selected by a user for further processing.

The term “dynamic switching” refers to changing, at runtime and according to current context or user operations, the content or parameters of an inquiry or processing flow without requiring system restart or static reconfiguration.

The server, the terminal, and the user cooperate in multiple embodiments to implement the claimed invention, as described below.

The terminal is a portable information processing apparatus such as a smartphone or tablet computer. The terminal includes a processor (for example, an application processor with CPU and GPU cores), a memory (for example, DRAM and nonvolatile flash storage), an imaging unit (for example, a rear camera module with a CMOS image sensor and lens), a display (for example, a liquid crystal display or organic light-emitting display), a user input interface (for example, a touch-sensitive panel and microphone), and a communication interface (for example, a Wi-Fi or cellular modem). The terminal executes an operating system such as a mobile operating system and an application program dedicated to in-store product information retrieval.

The server is an information processing apparatus such as a physical or virtual server deployed in a data center or cloud environment. The server includes at least one central processing unit, at least one graphics processing unit or dedicated accelerator, main memory, and persistent storage such as a solid-state drive. The server executes an operating system such as a server operating system and middleware such as a web server and an application server framework. The server further executes a trained image recognition model and a generative AI model client module that communicates with an external or internal generative information processing model.

The user operates the terminal in a physical store or similar environment. The user directs the imaging unit of the terminal toward a target, such as a merchandise item on a shelf, and causes the terminal to capture an image of the target. The terminal converts raw sensor output from the imaging unit into image data, for example, a compressed image file in a standard format. The terminal optionally augments the image data with additional metadata, such as timestamp, geolocation, or device orientation, obtained through sensors and operating system services. The server receives the image data from the terminal through a network. The server performs image recognition processing using a pre-trained neural network model. For example, the server loads an object detection model such as a convolutional neural network based architecture (for instance, a model with multiple convolutional, batch normalization, and nonlinear activation layers arranged in a feature-extracting backbone and a detection head) implemented by a framework such as a tensor processing library. The server resizes and normalizes the image data into a tensor representation with three color channels and predefined resolution. The server feeds this tensor into the image recognition model, which outputs detection results including bounding boxes, class labels, and confidence scores for detected objects.

The server identifies a target in the detection results that corresponds to a merchandise item by selecting a class label classified as a product category, such as beverage, cosmetic, or packaged food, with a confidence score greater than a predetermined threshold. The server generates target information by mapping the detected class and bounding box to higher-level attributes. For example, the server can perform optical character recognition on image regions inside the bounding box to extract characters from labels, then normalize these characters by comparing them to entries in a product master data structure. The server thereby creates target information that includes a merchandise category, merchandise attributes (such as brand, type, volume, or model), and identification information (such as a product code or barcode value). The server constructs a prompt sentence for a generative AI model by applying a prompt generation algorithm to the target information. The server stores prompt templates in a structured data format, where each template includes placeholder fields for a category, attributes, and requested information items. The server fills the placeholder fields with the target information and selects which information items to request (for example, description, reviews, price range, and recommended usage) according to system rules and possibly user preferences. The server thus generates a prompt sentence such as:
“Provide detailed information about the following product: a 750 ml red wine, brand A, vintage 2018. Include a concise product description, typical retail price range, user review summary, and recommended food pairings. Respond in English.”

In another example, the server generates a prompt sentence such as:
“Provide detailed information about Brand B Merlot 2019 (750 ml). Include tasting notes, typical retail price in the current country, an overview of user reviews, any notable awards or expert ratings, and recommended food pairings. Keep the answer concise and consumer-friendly.”

In yet another example, for a non-beverage product, the server generates a prompt sentence such as:
“Give a detailed yet concise description of this product: a premium dark chocolate bar, 70% cacao, 100 g, imported brand. Include taste profile, typical price range, user review summary, and any allergy-relevant ingredients. Respond in English.”

The server transmits the prompt sentence to a generative information processing model as part of a request. In one embodiment, the generative information processing model is a large-scale neural language model composed of multiple transformer blocks, each transformer block including multi-head self-attention layers, feed-forward layers, layer normalization, and learned positional encodings. The model is trained on large corpora of text data by minimizing a sequence prediction loss, such as cross-entropy loss between predicted next-token distributions and ground truth tokens, using gradient-based optimization such as stochastic gradient descent with variants such as Adam or AdamW. The model parameters, including weights of attention matrices and feed-forward layers, are updated iteratively during training.

The server formats the prompt sentence as input tokens by applying a tokenizer, such as a byte-pair encoding or similar subword segmentation algorithm. The server then transmits these tokens or their textual representation over a secure network connection to the environment in which the generative AI model executes. The generative AI model processes the tokens through its transformer architecture, computing attention scores, intermediate hidden states, and final output token distributions. The model generates output tokens that are decoded back into a natural language response. The server receives the generated related information as a text sequence, which describes the merchandise item in natural language, including one or more of a merchant description, evaluation summary, price information, inventory-related hints if available in the context, and recommended use or pairing information.

The server integrates the generative related information with structured data stored in one or more storage units. The server maintains a merchandise information storage unit implemented as a relational database or a key-value store that holds product identifiers, official product names, attributes, and other structured fields. The server also maintains an inventory information storage unit that holds stock quantities and status for each product across one or more physical store locations. The server further maintains a sales promotion information storage unit that stores data about active promotions, bundles, discounts, or loyalty program benefits.

The server applies reconciliation rules stored in configuration data structures to align the generative related information with the structured data. For example, when the generative AI model outputs a typical price range that conflicts with current price records in the merchandise information storage unit, the server identifies the discrepancy by comparing numerical values and tags the generative price as historical or typical while presenting the structured price as current. The server may also truncate or refine the generative description to avoid duplication with fixed safety-critical components such as allergen lists stored in the structured data. The server thereby generates integrated information that combines the generative text with authoritative structured fields, ensuring consistency and completeness. The server transmits the integrated information back to the terminal in a structured format, such as a data object containing fields for a merchandise description, evaluation summary, price comparison, inventory status, and sales promotion content. The terminal receives this structure and generates a display layout adapted to its screen size and orientation. The terminal renders the integrated information as a user interface that may include text sections, icons indicating stock status, and graphical markers for promotions.

The user views the integrated information on the display of the terminal and can make a purchase decision while physically present in the store. The system thereby links computational processing, including image recognition and a generative AI model, to control of display hardware in a specific real-world context and improves the functioning of the terminal and server by enabling more accurate and context-aware use of limited screen space, reduced interaction steps, and reduced need for manual search operations.

In an embodiment that implements emotional adaptation, the terminal acquires expression information from the user using the imaging unit or a front-facing camera and acquires voice information from a microphone. The terminal or the server processes this multimodal input using emotion analysis processing implemented with a classification neural network. For example, the server can run a convolutional neural network on facial images to extract feature vectors representing facial muscle configurations, and feed these vectors into a classifier that outputs probabilities for emotion classes such as satisfied, confused, or frustrated. The server can likewise compute acoustic features such as pitch, intensity, and spectral characteristics from voice data and feed these features into a recurrent or transformer-based classifier to estimate an emotional state.

The server uses the resulting emotion classification scores to adjust at least one of presentation content, presentation order, and level of detail of the integrated information. For instance, when the analysis indicates confusion, the server or terminal may prioritize simplified explanations and visual icons and reduce the number of technical terms. When the analysis indicates satisfaction and expertise, the server may present more detailed specifications and comparisons. This adaptation is realized by algorithmic rules and thresholds applied to the outputs of the emotion analysis network, rather than simple human-like intuition, and thus implements a concrete control flow in the terminal and server software that changes data selection and rendering patterns.

In another embodiment, the terminal allows the user to perform a selection operation on the captured image. The user taps or drags on the screen to specify a target region within the image. The terminal translates the user's gestures into coordinates, defines a region of interest, and transmits these coordinates along with the image data to the server. The server maps the selected region onto detected bounding boxes from the image recognition processing by computing intersection-over-union values between the user-selected region and each detected bounding box. The server then selects the bounding box with the greatest overlap and uses its associated detected class and attributes to generate target information. The server constructs a prompt sentence based on this specific target information, thereby dynamically switching inquiry content to focus on the selected target. This non-conventional combination of user-selected regions with learned recognition and prompt construction allows a single captured image with multiple products to be processed in a granular way with minimal user effort. The server improves processing efficiency and communication efficiency by limiting the number of generative AI calls and the amount of data transmitted. For instance, the server caches prompt sentences and corresponding responses when similar target information appears across different users or times. The server computes a hash or similarity measure on the target information and uses this as a key in a cache data structure. When a new request with similar target information is received, the server can retrieve a previously generated integrated information entry and update only dynamic fields such as inventory and current promotions. This reuse of generative results reduces repeated calls to the generative AI model and decreases network latency and computational load.

The server utilizes specific data structures and algorithms to coordinate the image recognition and generative AI path. The server maintains a pipeline processing module that receives image requests, assigns identifiers, and dispatches tasks to specialized modules for recognition, prompt generation, generative AI interaction, and reconciliation. Each module exchanges data in standardized object representations containing fields for category, attributes, confidence scores, and text segments. This modular configuration allows parallelization across multiple processor cores and GPUs and enables optimization such as batch processing of image recognition tasks and pooling of generative AI calls.

The system improves accuracy and reduces error compared to conventional manual lookup or simple template-based retrieval because the server derives prompt sentences from machine-recognized attributes and integrates multiple sources of information. The image recognition network has been trained using supervised learning on a labeled dataset of merchandise images, employing data augmentation techniques such as random cropping, rotation, and color jitter to enhance robustness to variations in capture angle and lighting. The generative AI model, trained on diverse corpora, supplies flexible natural language descriptions; however, the server limits this flexibility and enforces reliability by reconciling generative outputs with structured records using predetermined rules. This combined operation yields high-quality, contextually rich information while controlling hallucination or inconsistency. The system also improves technical performance in terms of processing latency and bandwidth. The terminal performs only lightweight preprocessing and defers heavy computation to the server or external generative model environment. The server uses efficient encoding of images and compresses intermediate data where appropriate. The server dynamically reduces the size of prompt sentences and the amount of text requested when network conditions are poor or terminal capabilities are limited. These adjustments are computed algorithmically based on measured latency and throughput metrics.

In another embodiment, the generative AI model can be partially or fully hosted on the server itself to reduce dependency on external infrastructure. In such a case, the server stores the model parameters locally and executes the transformer network using GPU acceleration. The server may compress or quantize the model weights to reduce memory usage and improve inference speed. The training method, including use of mini-batch gradient descent, backpropagation through the transformer layers, and regularization techniques such as dropout, is selected to yield a model that can respond within time constraints suitable for real-time in-store usage.

The system further provides technical advantages in data management. The server structures merchandise information, inventory information, and promotion information into normalized database schemas that include indexes on product identifiers and location fields. The integration logic accesses these databases using parameterized queries and transaction control to ensure consistent reads even when inventory updates occur concurrently. The reconciliation rules engine is implemented as a programmable module, enabling the operator to define new comparison and merging strategies without redesigning the entire application. These components collectively improve the manageability and scalability of the system.

The user thus interacts with a system that not only automates tasks but also fundamentally improves the way computers perceive, interpret, and present product-related data. The server and the terminal cooperate to transform raw sensor data and high-dimensional feature representations into actionable information in a way that enhances computational efficiency, accuracy, and adaptiveness beyond mere human manual operations.

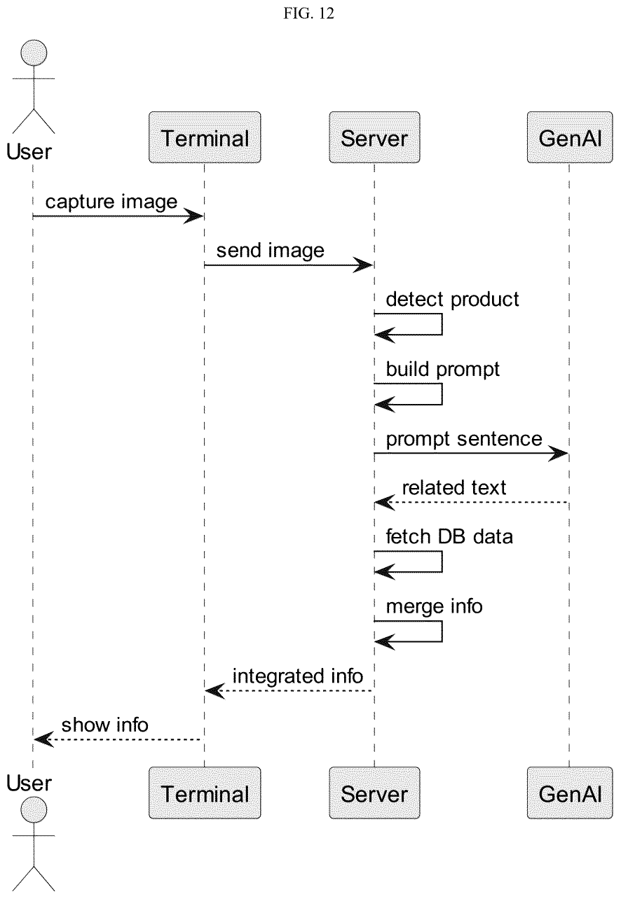

The following describes the processing flow using FIG. 12.

### Step 1:

The user operates the terminal to capture an image of a target.

The terminal activates its imaging unit, displays a live preview on the display, and waits for a user input such as a tap on a shutter button.

Input: raw optical signals received by the imaging unit and user input indicating capture timing.

The terminal converts the raw sensor signals into digital image data by performing sensor readout, analog-to-digital conversion, demosaicing, color correction, and compression into a standard format such as JPEG.

Output: compressed image data associated with metadata including capture time, terminal identifier, and optionally location information.

### Step 2:

The terminal prepares the captured image data for transmission to the server.

Input: compressed image data and metadata generated in Step 1.

The terminal packages the image data and metadata into a request message, for example an HTTPS POST request, using an internal data structure that includes fields for image bytes, timestamp, and location.

The terminal establishes a network connection and transmits the request to a predefined server endpoint.

Output: a network message containing the image data and metadata, delivered to the server.

### Step 3:

The server receives and stores the incoming request from the terminal.

Input: the network message containing image data and metadata from Step 2.

The server's communication module parses the HTTP headers and body, extracts the image bytes and metadata, and writes the image bytes to temporary storage such as a file or in-memory buffer.

The server associates a unique request identifier with the stored image entry and records the mapping between the request identifier and the metadata in a session data structure.

Output: a stored image record indexed by the request identifier and a corresponding session record containing metadata.

### Step 4:

The server performs image preprocessing for recognition.

Input: the stored image record from Step 3.

The server loads the image into memory, decodes the compressed format into a raw pixel array, and resizes the image to a fixed resolution required by an image recognition model, such as 640×640 pixels.

The server normalizes pixel values, for example by scaling them to a range [0,1] and subtracting channel-wise mean values, and converts the array into a tensor representation compatible with a neural network framework.

Output: a normalized image tensor ready for input into the image recognition model.

### Step 5:

The server performs object detection and classification on the image.

Input: the normalized image tensor from Step 4.

The server feeds the tensor into an image recognition model, such as a convolutional neural network-based object detector, that has been previously loaded into GPU or CPU memory.

The model executes convolution, pooling, non-linear activation, and detection head computations to produce bounding boxes, class scores, and confidence scores for multiple candidate objects.

The server applies post-processing, such as non-maximum suppression, to remove overlapping bounding boxes and selects objects with confidence scores above a threshold.

Output: a list of detected object entries, each including bounding box coordinates, class label, and confidence value.

### Step 6:

The server determines whether a detected object corresponds to a merchandise item and generates target information.

Input: the list of detected object entries from Step 5 and the session record from Step 3.

The server compares each class label against a predefined set of merchandise-related categories and filters out non-merchandise classes.

For selected merchandise objects, the server extracts the corresponding image regions based on bounding box coordinates and performs additional processing such as optical character recognition to detect text on labels or barcodes.

The server maps recognized text and visual features to entries in a product master database by executing database queries using similarity matching or exact identifier lookup.

The server compiles target information objects that include a merchandise category, merchandise attributes (such as type, size, or composition), and identification information (such as product codes).

Output: one or more target information objects associated with the request identifier.

### Step 7:

The server constructs a prompt sentence for a generative AI model based on the target information.

Input: a target information object from Step 6 and user or system preference data stored in configuration.

The server selects a prompt template according to the merchandise category and the type of information to be requested, such as description, review summary, and price range.

The server inserts values from the target information, such as brand, type, and size, into placeholder positions in the template and sets flags indicating requested information items and expression style, for example the desired language and level of detail.

The server thereby generates a complete prompt sentence as natural language text.

Output: a prompt sentence tailored to the recognized merchandise item.

### Step 8:

The server sends the prompt sentence to the generative AI model and obtains related information.

Input: the prompt sentence from Step 7.

The server tokenizes the prompt sentence using a subword or similar tokenizer to create a sequence of token identifiers and wraps these tokens into a request format defined by the generative AI model interface.

The server transmits the request via a network to an environment hosting a generative AI model, where a transformer-based neural network processes the token sequence, computes attention and feed-forward transformations across multiple layers, and returns output tokens representing generated text.

The server receives the output tokens and decodes them back into a natural language text string that describes the merchandise item and includes requested information such as description, review summary, and typical price range.

Output: related information in natural language text generated by the generative AI model.

### Step 9:

The server retrieves structured merchandise, inventory, and promotion data corresponding to the target information.

Input: the target information from Step 6 and the session record from Step 3.

The server queries a merchandise information storage unit using the identification information as a key to obtain official product records, including identifier, name, and canonical attributes.

The server queries an inventory information storage unit using a combination of product identifier and store or region code to obtain current stock levels and inventory status.

The server queries a sales promotion information storage unit for active promotions associated with the product identifier and the user's store or region.

The server consolidates these database query results into a structured data object containing authoritative product, inventory, and promotion fields.

Output: a structured data object with merchandise, inventory, and promotion information.

### Step 10:

The server reconciles the generative related information with the structured data to generate integrated information.

Input: the related information text from Step 8 and the structured data object from Step 9.

The server parses the related information into segments corresponding to content types such as description, price, and usage notes, using markers in the prompt sentence and natural language parsing rules.

The server applies reconciliation rules to compare values extracted from the generative text, such as a typical price range, with corresponding numerical fields in the structured data, and marks structured values as authoritative when conflicts arise.

The server merges the generative text with structured fields by inserting or replacing portions of the text to incorporate up-to-date inventory status and promotion details and by trimming or annotating generative portions that diverge from critical database records.

The server assembles the merged content into an integrated information object that includes a final description, a review summary, a price comparison section, an inventory status indicator, and a list of promotions.

Output: an integrated information object that combines generative and structured information for the merchandise item.

### Step 11:

The server transmits the integrated information to the terminal for presentation.

Input: the integrated information object from Step 10 and the session record from Step 3 containing terminal addressing information.

The server serializes the integrated information object into a response format, such as a structured message containing named fields, and attaches it to an HTTP response keyed by the request identifier.

The server sends the response over the network to the terminal endpoint recorded in the session.

Output: a network response message containing the integrated information, delivered to the terminal.

### Step 12:

The terminal receives and interprets the integrated information.

Input: the network response message from Step 11.

The terminal's communication module parses the response headers and body, extracts the integrated information object, and maps its fields into application-specific data structures, such as objects representing description, rating summary, price entries, stock state, and promotions.

The terminal determines display layout parameters based on screen size, orientation, and user settings, and prepares user interface elements such as text views, icons, and buttons.

Output: a set of populated user interface components representing the integrated information, ready for rendering on the display.

### Step 13:

The terminal displays the integrated information and receives user interaction.

Input: the user interface components from Step 12 and ongoing user input events.

The terminal renders the text and graphical elements on the display so that the user can view the merchandise description, evaluation summary, price comparison, inventory status, and promotion content while physically present near the product.

The user inspects the presented information and may provide additional input, such as selecting a different target region in the image, requesting more details, or initiating a navigation or purchase action.

The terminal captures these user inputs as touch events or similar signals and, if necessary, generates new requests to the server that include updated selection data or context.

Output: visual presentation of integrated information to the user and, optionally, new interaction data to be processed in subsequent cycles.

### Step 14:

The terminal and the server optionally adjust content based on user emotion analysis.

Input: expression information or voice information captured by the terminal, as well as the integrated information object from Step 10.

The terminal captures facial images or voice samples using the imaging unit or microphone and passes these sensor data to the server.

The server applies feature extraction and classification algorithms to estimate the user's emotional state and modifies configuration parameters such as level of detail or ordering of sections in the integrated information.

The server or terminal then regenerates or rearranges parts of the user interface, for example, by shortening text, emphasizing key points, or changing the focus of displayed content.

Output: an adapted version of the integrated information and user interface that reflects an emotion-based adjustment of presentation content, order, or detail.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional interactive information systems generally rely on predefined user interface flows and static rule-based mappings between selected targets (such as items or resources) and operations (such as purchase, reservation, or content access). In such systems, when a user selects a target on a terminal device, a server typically looks up a fixed set of associated operations from a configuration table or application code and presents those operations as buttons or links. This architecture presents several technical problems.

First, because the mapping from targets to operations is statically defined in application logic, the server must execute complex conditional branches and template selection routines to determine which operations to show for each target and each context. This increases processing complexity on the server, leads to code bloat, and makes it difficult to maintain and optimize the underlying software. Modification of supported operations or adaptation to new usage contexts often requires deployment of new application versions, which imposes a high maintenance burden and reduces system agility.

Second, conventional systems have limited ability to exploit rich contextual signals such as user operation history and environment information in real time. Even when such signals are collected, they are typically used in isolated recommendation modules and are not deeply integrated into the operation-generation logic of the user interface. As a result, the set of operations presented to the user tends to be generic and not well tuned to the current context. This can cause the user to perform additional navigation and selection steps, increasing the number of interactions, generating redundant client-server communications, and degrading overall throughput and responsiveness of the system.

Third, in known architectures, the terminal device usually serves only as a passive rendering endpoint. Script programs executed on the terminal detect user events and send simple identifiers to the server, but they do not actively participate in a dynamic operation-generation loop driven by a generative artificial intelligence model. Because the server does not receive a structured, event-driven trigger flow specifically designed for AI-based operation generation and execution, the server cannot efficiently coordinate between event detection on the client side, prompt construction on the server side, and subsequent action execution. This results in fragmented processing paths, inconsistent data formats, and suboptimal utilization of computational resources, including the computing infrastructure used for generative artificial intelligence inference.

Fourth, conventional systems that employ machine learning typically integrate predictive models as auxiliary recommendation engines, while leaving the core user-interface control and action definition logic unchanged. In such systems, the server still needs to implement rigid user-interface state machines and manual association rules, and the machine learning components operate as optional advisers. This split architecture fails to fully leverage generative artificial intelligence models for dynamically defining and structuring operations themselves, thus limiting the potential for reducing server-side control complexity and improving adaptability.

Accordingly, there is a need for a computer-implemented technique that improves the functioning of a server-based information processing system by (i) dynamically generating operation candidates based on target-related information and contextual information using a generative artificial intelligence model, (ii) structuring and presenting those operation candidates to a terminal device in a standardized, machine-interpretable format, and (iii) tightly coupling terminal-side event monitoring with server-side AI-driven operation generation and execution. Such a technique should reduce the reliance on hard-coded condition branches, decrease the number of manual configuration steps for introducing new operations or contexts, and improve the efficiency and responsiveness of user interface control at the system level.

The specific processing by the specific processing unit 290 of the data processing device 12 in Example 2 is realized by the following means.

The present invention provides a server comprising a processor and a memory, the processor being configured to cause a communication interface to transmit, to a terminal device, screen interface data including markup information and script information for rendering a visual interface that enables a user to manually select an operation target and to detect a user operation on the operation target; receive, from the terminal device, identification information representing an operation target manually selected by the user; acquire, from the memory, target-related information associated with the identification information; generate a prompt sentence based on the target-related information and application context information, the prompt sentence being configured to cause a generative artificial intelligence model to design one or more operations executable by the user with respect to the operation target; provide the prompt sentence to the generative artificial intelligence model and obtain response information including operation candidates; structure the operation candidates as operation information including internal operation codes and display labels, and combine the operation information with the target-related information to generate operation presentation data; transmit the operation presentation data to the terminal device so that the terminal device displays a dynamic screen including detail information of the operation target and the operation candidates; receive, from the terminal device, operation identification information representing an operation candidate selected by the user; and execute, based on the operation identification information and information associated with the operation target, at least one of a transaction process and an information-provision process and cause a result of the process to be transmitted to the terminal device. This enables the server to offload complex, static rule-based user-interface control logic into a dynamic, AI-driven operation-generation process, to tailor operations to the user by incorporating context information into the prompt sentence, and to coordinate terminal-side event detection with server-side generative processing, thereby improving the overall efficiency, adaptability, and technical performance of the computer-implemented interaction system.

The term “system” refers to a combination of one or more information processing apparatuses including at least a server-side apparatus and one or more terminal devices, together with software components executed thereon, that cooperate to perform the processing described in the claims.

The term “processor” refers to one or more hardware processing units, such as a central processing unit or a graphics processing unit, capable of executing instructions to perform arithmetic operations, logical operations, control operations, and data transfer operations in order to implement the claimed functions.

The term “memory” refers to one or more storage units, such as a semiconductor memory, magnetic storage, or optical storage, configured to store programs, configuration data, and runtime data used by the processor to perform the claimed processing.

The term “communication interface” refers to a hardware and software combination that enables data exchange between the system and external devices or networks, including, for example, network interface controllers and communication protocols for transmitting and receiving messages.

The term “terminal device” refers to an electronic device operated by a user, such as a portable terminal, a stationary terminal, or a display-equipped computing device, which executes a browser or application and presents information to the user while sending user input information to the server.

The term “screen interface data” refers to data transmitted from the server to the terminal device that defines a user interface layout and behavior, including structural and behavioral elements for rendering and interacting with screen content.

The term “markup information” refers to structured description data, such as hierarchical text or tag-based data, that specifies the arrangement, structure, and identification of user interface elements on a display.

The term “script information” refers to executable program code, such as an interpreted or compiled script, that runs on the terminal device and controls dynamic behaviors, event handling, and communication with the server.

The term “visual interface” refers to a collection of graphical elements rendered on a display unit, such as text, images, icons, and interactive controls, that allows a user to view information and perform operations by direct manipulation.

The term “operation target” refers to an object, entity, or information unit, such as an item, resource, or content element, on which the user is permitted to perform one or more operations in the system.

The term “user operation” refers to an input action performed by a user on the terminal device, such as a selection, activation, or manipulation of a screen element, including a click, tap, touch, or keyboard input.

The term “identification information” refers to data that uniquely or distinguishably represents a particular object or entity within the system, such as an identifier, code, or key used for retrieving or associating data.

The term “target-related information” refers to data associated with an operation target, including attributes, metadata, and state information, such as descriptive text, status values, or pricing data, which are used for presenting information and determining available operations.

The term “application context information” refers to data representing a state or environment of an application, such as a service type, user role, temporal context, or device type, which influences the selection and generation of operations for an operation target.

The term “prompt sentence” refers to a text or structured input message that is constructed by the processor and provided to a generative artificial intelligence model to specify a request or instruction for generating operation candidates or related information.

The term “generative artificial intelligence model” refers to a machine learning model, such as a neural network-based model, trained to generate output data including text or structured information in response to input data such as prompt sentences and context information.

The term “response information” refers to output data produced by the generative artificial intelligence model in response to a prompt sentence, including descriptions, structured data, or proposals relating to operations for an operation target.

The term “operation candidate” refers to a proposed operation, determined or suggested by the generative artificial intelligence model, that is executable by the user with respect to an operation target, such as a transactional or informational action.

The term “operation information” refers to structured data representing operation candidates in a machine-interpretable format, including one or more internal operation codes, display labels, and optionally parameters required for execution.

The term “internal operation code” refers to a machine-oriented identifier associated with an operation candidate, which is used by the server to map the operation candidate to corresponding processing logic or resources.

The term “display label” refers to a text string or similar descriptive element intended to be shown on the user interface, which provides a human-readable description of an operation candidate.

The term “operation presentation data” refers to a data structure generated by the server that combines target-related information and operation information, and that is used by the terminal device to render a dynamic screen including details of the operation target and selectable operations.

The term “dynamic screen” refers to a screen displayed on the terminal device whose content and layout can be updated or changed in response to data received from the server or user interactions, without requiring full reloading of a static page.

The term “operation identification information” refers to data representing a particular operation candidate selected by the user among multiple candidates, including an operation code or other identifier used for executing corresponding processing.

The term “transaction process” refers to a sequence of operations executed by the server to modify or create records or states related to a business or system transaction, such as reservation, purchase, enrollment, or resource allocation.

The term “information-provision process” refers to processing performed by the server to acquire, generate, or select information, such as content retrieval or recommendation generation, and to provide the information to the terminal device for presentation to the user.

The term “operation history information” refers to data representing past user interactions with the system, including records of selected targets, selected operations, timestamps, and related outcomes.

The term “environment information” refers to contextual data related to the current or surrounding environment of the user or system, such as device characteristics, location information, time information, network conditions, or usage context.

The term “script program” refers to an executable program, typically interpreted or just-in-time compiled on the terminal device, that performs event monitoring, user interface updates, and communication with the server within the user interface environment.

The term “input operation event” refers to a detectable event generated by the user's interaction with the terminal device, such as a mouse event, touch event, keyboard event, or gesture event, that is captured and processed by the script program.

The term “display unit” refers to a hardware component, such as a liquid crystal display, organic light-emitting diode display, or other screen device, configured to visually present the user interface and information output from the terminal device.

The term “execution of a process corresponding to the selected operation candidate” refers to performing, by the server, specific processing logic associated with an operation candidate selected by the user, including any necessary computations, database operations, or communications with external systems.

In one embodiment, a server provides a system that dynamically generates and presents operation candidates for user-selected targets by using a generative AI model in cooperation with a terminal. The server includes at least one processor, a memory, a communication interface, and a non-transitory storage medium storing program instructions.

The terminal includes at least one processor, a memory, a communication module, a display unit, and an input unit such as a touch panel or pointing device. The user operates the terminal to select targets and operations.

The server executes an operating system such as a general-purpose server operating system and a web application framework such as a generic web framework. The server further executes a model-serving framework such as a neural-network inference engine running on at least one central processing unit (CPU) and, in some embodiments, on at least one graphics processing unit (GPU). The terminal executes a browser application or a native application that processes markup information and script information to render a visual interface and to communicate with the server over a network.

The server stores, in the memory or in an external database management system such as a relational database, target-related information for multiple operation targets. The server expresses each operation target as a structured data record including a target identifier, descriptive attributes (for example, a name, a category, and text descriptions), state attributes (for example, availability, remaining quantity, or status flags), and optional user-feedback attributes (for example, rating scores or review summaries). The server further stores user-related information such as user identifiers, operation history information, and environment information including device type, language preference, and time-zone data.

The server generates screen interface data that includes markup information and script information. The markup information defines a hierarchical structure of screen elements such as target-list elements, detail-display regions, and operation-button regions. The script information defines event-handling procedures for detecting user operations on the screen elements, accessing identification information embedded in the elements, and transmitting the identification information to the server through the communication interface. The server sends the screen interface data to the terminal via a network such as the Internet using a standard transport protocol.

The terminal receives the screen interface data and causes the browser or application to interpret the markup information and to execute the script information. The terminal renders, on the display unit, a visual interface in which multiple operation targets appear as selectable items. The terminal associates each operation target with identification information maintained in a local data structure (for example, a mapping from visual element identifiers to target identifiers) and enables the user to select a desired operation target by performing a user operation such as a touch gesture or mouse click.

The user observes the visual interface on the display unit and selects an operation target. The terminal detects the user operation via the input unit and the script program. The terminal identifies the selected operation target by accessing the corresponding identification information and transmits this identification information, together with optional user context information, to the server through the communication module. The user may further select one of the operation candidates presented on the display unit in a subsequent stage; however, the selection process itself is separated from the generation process of the operation candidates on the server.

The server receives the identification information representing the operation target from the terminal. The server accesses the database to retrieve target-related information associated with the received identification information. The server constructs an internal data object representing the current target context, including the target-related information and the application context information such as service domain, user role, and device category. The server may further retrieve operation history information representing past user interactions and environment information representing current usage conditions, and may associate these with the target context.

The server then generates a prompt sentence to be provided to a generative AI model. The server arranges the target-related information, application context information, operation history information, and environment information into a textual specification that follows a predetermined format. In one example, the server constructs a prompt sentence as follows: “You are a system component that designs user interface operations for an interactive information service.

Current item:
Identifier: [target identifier]
Name: [target name]
Category: [target category]
Status: [availability or stock status]
Description: [short text description]
   User context:
Device type: [device category]
Language: [language code]
Recent operations: [summary of operation history]

### Task:

Based on the above information, generate a set of operations that a user can execute on this item. For each operation, output:
An internal operation code in lowercase with underscores.
A short label suitable for display on a button.

Only include operations that are technically valid for this item and context.”

The server passes this prompt sentence to the generative AI model via the model-serving framework. The generative AI model is, in one embodiment, a transformer-based neural network model that includes an encoder-decoder or decoder-only architecture with multiple attention layers, feedforward layers, and embedding layers. The model receives the prompt sentence as a sequence of tokens, transforms the tokens into dense vector representations, and processes the sequence using self-attention mechanisms that compute attention weights based on pairwise relationships between tokens. The model employs learned parameters such as embedding matrices, attention projection matrices, and feedforward network weights.

The generative AI model has been trained prior to deployment using supervised learning and, in some embodiments, reinforcement learning from human feedback. During training, the model receives training examples that consist of input prompt sentences and desired output text sequences describing operation candidates. The training procedure defines a loss function such as a cross-entropy loss between the predicted token distribution and the target token sequence. The training system computes gradients of the loss function with respect to model parameters using backpropagation and updates the parameters using an optimization algorithm such as stochastic gradient descent or Adam. The training system may perform data augmentation by varying text templates, inserting paraphrased descriptions, and perturbing context information to improve robustness. In some cases, the training incorporates constraints that penalize invalid or redundant operation codes, thereby encouraging the model to generate structured and machine-usable output.

When the server invokes the generative AI model at inference time, the model performs only forward computation without parameter updates. The model sequentially generates output tokens conditioned on the prompt sentence, controlling generation parameters such as temperature or sampling strategy to balance diversity and determinism. The model outputs a text sequence that describes multiple operation candidates in a machine-parsable format, including internal operation codes and human-readable labels.

The server receives the text output from the generative AI model and parses the text according to the predefined formatting rules used in the prompt sentence. The server extracts, for each operation candidate, an internal operation code and a display label. The server may enforce additional rule-based filters or mapping tables to remove unsafe or unsupported operations and to map generic operation codes to specific system-level procedures. The server structures the validated operation candidates into operation information, which includes the internal operation codes, the display labels, and optional parameters indicating constraints or required input fields.

The server combines the operation information with the target-related information to produce operation presentation data. The server arranges this data into a structured representation that identifies which UI region on the terminal should display each element, which operations should be grouped together, and which interaction patterns should be applied. The server sends the operation presentation data to the terminal through the communication interface. The terminal receives the operation presentation data and updates the visual interface without complete reloading of the original page. The terminal maps the operation information to actual UI components, such as buttons or menu items, and associates each component with the corresponding internal operation code. The terminal displays the target details and the set of operation candidates in a layout determined by the markup and style rules. The user can then see personally tailored operations that change depending on the selected target and the context.

The user selects one of the operation candidates presented on the display unit. The terminal detects this user operation and obtains the internal operation code associated with the selected operation candidate. The terminal transmits operation identification information, which includes the internal operation code and the target identifier, to the server. The server receives the operation identification information and uses it as a key to determine which processing logic to invoke. The server executes a transaction process or an information-provision process according to the operation code and the target-related information, such as updating records in the database, performing complex consistency checks, or requesting information from external services. The server generates a processing result and returns it to the terminal. The terminal then presents the processing result in the visual interface, such as a confirmation message or updated data display.

This architecture provides an improvement in computer technology for several reasons. First, the server no longer maintains extensive static mapping tables between targets and operations. Instead, the server compresses such mapping complexity into the generative AI model and simple rule-based filtering. This reduces the number of conditional branches in the application code and simplifies the server-side control flow. As a result, the server executes fewer branching instructions and repeated template-composition routines, leading to improved CPU cache efficiency, reduced instruction pipeline stalls, and consequently improved processing speed for large-scale deployments.

Second, the server uses the operation history information and environment information as structured inputs in the prompt sentence. By encoding these signals into the prompt sentence, the system leverages the generative AI model's learned ability to correlate context with operation patterns. This integration reduces the need for separate recommendation modules and additional database queries for manually coded personalization. The system therefore reduces the overall number of database accesses and network round trips compared to conventional multi-module architectures, which in turn reduces communication load and improves throughput.

Third, the generative AI model employs a transformer-based architecture with self-attention to consider multiple attributes simultaneously when constructing operation candidates. In contrast, a conventional rule-based system requires separate evaluation of each condition and multiple nested checks for each attribute, which scale poorly as the number of attributes and service types grows. The transformer architecture uses matrix multiplications and vectorized operations that modern CPUs and GPUs can execute efficiently, taking advantage of hardware-level parallelism. This leads to better scalability in terms of computation time as the number of targets and contexts increases, and contributes to higher responsiveness for interactive systems.

Fourth, the server utilizes non-conventional, model-based rules for constructing operation candidates. While a human operator or a rule engine might define operations by writing case-by-case rules, the generative AI model, having been trained on large and diverse examples, can detect subtle attribute combinations and user patterns and propose operations that are not trivially expressible as a small set of if-then rules. The server then validates the model outputs under a restricted grammar and predefined policy constraints. This combination of learned pattern extraction and constrained post-processing constitutes a non-human, nontrivial procedure that improves the accuracy of operation selection while maintaining technical safety and consistency.

Fifth, because the server constructs the prompt sentence in a highly structured manner, with clear segments for item attributes, user context, and task description, the system reduces variability in the model's output and enables consistent parsing. This structured prompt design minimizes the likelihood of malformed or ambiguous outputs, thus reducing error-handling overhead and the need for re-queries. From a technical perspective, this results in lower processing latency and fewer wasted CPU and GPU cycles.

The described system is not merely automating a human mental task but is reorganizing how the server and terminal share computational responsibilities. The terminal performs low-latency event detection and rendering, while the server centralizes high-cost generative computation and database access. The event-driven integration between the terminal's script program and the server's generative processing ensures that AI inference is invoked only when necessary and with compact, context-rich prompts, thereby reducing network bandwidth consumption and inference frequency. This division of labor leads to improved resource utilization across the network and hardware infrastructure.

In a variation of this embodiment, the server uses a smaller, domain-specialized generative AI model for specific service types. The server selects the appropriate model instance based on the application context information encoded in the prompt sentence. By matching model capacity to domain complexity, the system further improves computational efficiency and reduces inference time. In another variation, the server maintains a cache of previously generated operation candidates keyed by target identifier and coarse-grained context. When a similar context occurs, the server reuses cached operation information instead of invoking the generative AI model immediately, which further reduces computation and network latency.

In an additional embodiment, the server enriches the prompt sentence with derived features computed from the operation history information, such as frequency counts of certain operations, recency scores, or aggregate outcome metrics. The server calculates these derived features using efficient numeric algorithms and encodes them into the prompt text in a standardized format. This enables the generative AI model to treat such features as part of the input sequence and to adjust operation proposals based on more precise behavioral statistics, thereby improving the precision of the proposed operations and reducing unnecessary operations that would not be selected by the user.

In yet another embodiment, the server coordinates multiple generative AI models with different architectures, such as a transformer-based text model and a separate sequence-classification model trained to predict the likelihood that a proposed operation will be executed. The server may first generate operation candidates with the text model and then score or filter them with the classification model. This multi-model composition enhances the system's technical robustness and operation-selection accuracy while still being driven by the structured prompt sentence created from the target-related information and context.

Through these embodiments and variations, the server, the terminal, and the generative AI model cooperate to form a computer-implemented system that improves the internal functioning of interactive information services. The system achieves reduced rule-maintenance overhead, improved scalability of operation-generation logic, decreased network and processing load, and enhanced adaptability of the user interface behavior in response to complex, multidimensional context information.

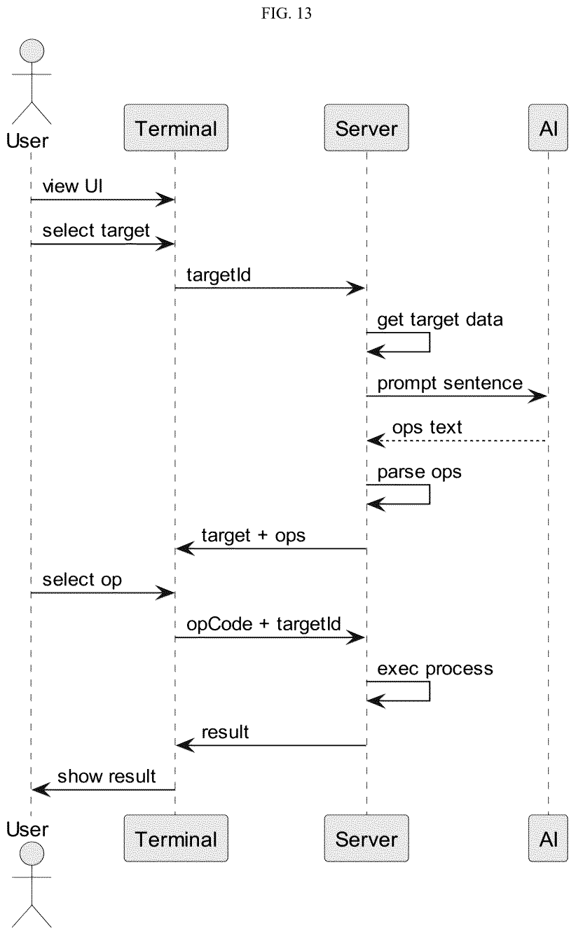

The following describes the processing flow using FIG. 13.

### Step 1:

Server prepares and transmits screen interface data.

Server uses application configuration data and target index data as input. Server generates markup information defining layout regions for a target list, a target-detail area, and an operation-button area, and generates script information defining event handlers for user selection events and communication routines. Server combines these elements into screen interface data and outputs the screen interface data to the terminal via a communication interface.

Server performs data processing by constructing hierarchical structures for screen elements, assigning logical identifiers to each target placeholder, and embedding references to target identifiers in attributes. Server then serializes this structure into a format interpretable by a browser or native application and sends it as the response payload.

### Step 2:

Terminal renders the visual interface and prepares event handling.

Terminal receives the screen interface data from the server as input. Terminal parses the markup information to build an internal representation of the screen structure, and executes the script information to configure event listeners for user operations such as clicks or taps on target elements. Terminal outputs a rendered visual interface on the display unit, showing a list of selectable targets.

Terminal performs data processing by mapping each rendered screen element to a corresponding logical identifier, caching these mappings in a local data structure. Terminal also initializes internal state variables that will hold selected target identifiers and later operation codes.

### Step 3:

User selects an operation target.

User views the visual interface on the terminal's display unit as input. User decides on a particular target of interest and performs an operation such as clicking, tapping, or otherwise selecting the visual representation of that target. User's action produces a physical input event to the terminal.

### Step 4:

Terminal detects the target selection and sends target identification information.

Terminal receives the low-level input event generated by the user as input. Terminal executes the previously installed event handler, identifies the screen element associated with the event, and retrieves the target identifier assigned to that element. Terminal then constructs a message containing the target identifier, and optionally user context data such as a session identifier or language setting, and outputs this message to the server via the communication module.

Terminal performs data processing by translating raw input events into a higher-level representation containing the target identifier and user context, packaging these elements into a structured message suitable for transmission.

### Step 5:

Server acquires target-related information.

Server receives the message from the terminal, including the target identifier and optional context information, as input. Server uses the target identifier to query a database or other memory resource and retrieves target-related information such as a name, category, descriptive text, status values, and any associated metadata. Server outputs a structured representation of the target-related information for use in subsequent processing.

Server performs data processing by executing data retrieval operations, filtering database fields to include only relevant attributes, and normalizing these attributes into a consistent internal schema.

### Step 6:

Server incorporates context information.

Server uses the target-related information, the received user context information, and stored operation history information as input. Server retrieves operation history for the same user or for similar users, as well as environment information such as device type, time zone, and current application mode. Server combines these data into an aggregated context object and outputs a unified context representation.

Server performs data processing by aggregating multiple data sources, computing derived features such as frequency counts of past operations or recency scores, and encoding these features as structured fields to be consumed by later components.

### Step 7:

Server generates a prompt sentence for the generative AI model.

Server uses the target-related information and the aggregated context object as input. Server constructs a prompt sentence that describes the current item, the user context, and the generation task in natural-language form. The prompt sentence specifies requirements such as output format, internal operation code style, and constraints on permissible operations. Server outputs the completed prompt sentence as a text string.

Server performs data processing by formatting numerical and categorical attributes into human-readable phrases, concatenating them in a predefined order, and inserting delimiters and keywords that facilitate consistent interpretation by the generative AI model.

### Step 8:

Server requests operation candidates from the generative AI model.

Server uses the prompt sentence as input to the generative AI model. Server sends the prompt sentence to a model-serving component and requests generation of operation candidates. The generative AI model processes the prompt sentence and outputs response text that describes one or more operation candidates, each including an internal operation code and a display label.

Server receives the response text from the generative AI model as output.

Within the model, the prompt sentence is tokenized, converted into vector representations, and processed through multiple attention and feedforward layers to compute probability distributions over output tokens. The model performs sequential decoding to generate tokens that form operation descriptions consistent with the constraints encoded in the prompt sentence.

### Step 9:

Server parses and validates operation candidates.

Server receives the response text from the generative AI model as input. Server parses the text according to the expected structure, extracting, for each operation candidate, an internal operation code and a display label. Server validates each operation candidate using rule-based filters and mapping tables to ensure that only supported and safe operations are retained.

Server outputs a set of validated operation candidates as structured operation information.

Server performs data processing by scanning the response text, splitting it into segments, matching segments against patterns specifying the required format, and discarding segments that fail to satisfy syntax or policy constraints.

### Step 10:

Server constructs operation presentation data.

Server uses the validated operation information and the target-related information as input.

Server combines these data to create operation presentation data that specifies how the target details and the operation candidates should be presented on the terminal. Server associates each operation candidate with a region or component within the user interface and outputs the operation presentation data to the terminal through the communication interface.

Server performs data processing by organizing the operation information into a hierarchy aligned with the UI layout, assigning identifiers and ordering information to each operation candidate, and embedding display labels and internal codes in a transportable data structure.

### Step 11:

Terminal updates the visual interface with dynamically generated operations.

Terminal receives the operation presentation data from the server as input. Terminal parses the data, identifies the target detail region and the operation-button region, and updates these regions according to the received instructions. Terminal generates visual components such as buttons for each operation candidate and associates each component with the corresponding internal operation code and target identifier. Terminal outputs an updated visual interface on the display unit, showing the target details and the set of available operations.

Terminal performs data processing by mapping abstract operation entries to actual screen elements, updating existing DOM-like structures or UI component trees, and refreshing only the affected parts of the display to minimize rendering overhead.

### Step 12:

User selects one of the dynamically generated operation candidates.

User views the updated visual interface on the terminal's display unit as input. User evaluates the presented operation candidates and selects a desired operation, for example by touching an operation button or clicking a corresponding icon. User's action generates an input event that is processed by the terminal.

### Step 13:

Terminal captures the selected operation and transmits operation identification information.

Terminal receives the input event associated with the user's selection as input. Terminal executes an event handler that retrieves the internal operation code and the associated target identifier from the selected visual component. Terminal constructs operation identification information containing the internal operation code, the target identifier, and optional user context data. Terminal outputs this operation identification information to the server via the communication module.

Terminal performs data processing by translating the raw event into a structured representation, mapping UI elements to logical operations, and encapsulating the necessary identifiers in a transmission-ready format.

### Step 14:

Server executes processing corresponding to the selected operation.

Server receives the operation identification information from the terminal as input. Server examines the internal operation code to determine which processing logic to execute and uses the target identifier to access the relevant target-related information. Server performs a transaction process or information-provision process accordingly, which may include database updates, consistency checks, and interactions with external services. Server outputs a processing result that describes success or failure and includes any updated state or information required by the terminal.

Server performs data processing by applying the selected operation to the stored data, updating records, calculating derived values such as new totals or status flags, and generating machine-readable result data.

### Step 15:

Terminal presents the processing result to the user.

Terminal receives the processing result from the server as input. Terminal interprets the result to determine how to update the visual interface, such as displaying a confirmation message, updating status indicators, or refreshing parts of the target details. Terminal outputs an updated visual interface that reflects the outcome of the selected operation.

Terminal performs data processing by mapping result codes and messages to screen elements, adjusting internal state to reflect the new system conditions, and redrawing affected visual components on the display unit so that the user can confirm the completion of the operation.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional information presentation systems that use cameras on portable terminals and remote servers suffer from several technical limitations. First, these systems typically perform object recognition and information retrieval as separate, static operations. Image data is captured, a fixed classification is obtained, and a predetermined set of information (for example, a static product page) is returned. The processing pipeline is not designed to construct rich, context-aware prompt sentences for a generative AI model, and therefore cannot leverage such models to dynamically generate explanations, summaries, or recommendations. As a result, the expressiveness and adaptability of the system output are limited, and the interaction between the user interface on the terminal and the server-side computation is inefficient.

Second, existing architectures generally do not treat the combination of (i) structured base data retrieved from storage, (ii) automatically constructed natural-language prompt sentences, and (iii) generative AI model output as a unified computational pipeline. The server and the terminal exchange either raw data or long, unstructured text, which leads to redundant computation, inefficient bandwidth usage, and increased latency. The absence of an integrated prompt-construction and post-processing mechanism also makes it difficult to ensure that the generative AI model output is constrained and aligned with the object type and available base data.

Third, typical systems lack a technically integrated emotion-aware feedback loop. Although separate emotion recognition technologies exist, they are not tightly coupled to the generation of prompt sentences and the invocation of generative AI models. In many systems, user emotion is either ignored or used only for superficial UI changes on the terminal, without affecting the content selection, level of detail, or recommendation strategy of server-side processing. This results in a mismatch between the user's real-time state and the information that the system generates and transmits, leading to unnecessary server calls, repeated or irrelevant content, and degraded overall system efficiency.

Fourth, conventional systems often handle user operations such as tapping, gaze selection, or voice commands in an ad-hoc manner, mapping them directly to static functions (for example, open a fixed page, show a fixed list). These systems do not generate structured prompt sentences that encode the selected operation (such as comparison, alternative suggestion, simplified explanation, or special offers) together with object classification and attribute information. Consequently, the server cannot use a uniform, programmable interface to control a generative AI model and must rely on custom code paths per function, which increases implementation complexity and reduces scalability.

Therefore, there is a need for a computer-implemented system that technically improves the way a server and a portable terminal cooperate to (i) obtain object classification and attribute information from captured images, (ii) retrieve structured base data, (iii) automatically build context-rich prompt sentences, (iv) invoke a generative AI model to generate constrained related information, and (v) integrate emotion analysis results and user-selected actions into subsequent prompt-generation and information-generation cycles. Such a system should improve processing efficiency, reduce redundant communication, and enhance the adaptability and relevance of the generated information in a technically coordinated manner.

The specific processing by the specific processing unit 290 of the data processing device 12 in Application Example 2 is realized by the following means.

The present invention provides a server comprising a processor configured to receive, from a portable information processing apparatus, image data of an object captured by an imaging unit and classification information and attribute information of the object obtained by applying an image processing algorithm and an object recognition algorithm to the image data; to search structured data stored in an information storage device based on the classification information and the attribute information and to acquire basic information related to the object; to generate, in accordance with the basic information and operation content selected by a user, a prompt sentence that defines, in natural language, information provision content to be executed for the object; to input the prompt sentence and at least a portion of the basic information to a generative information processing model and to cause the generative information processing model to generate related information including at least one of explanation information, summary information, and recommendation information concerning the object; to integrate the related information with the basic information and construct display information including, in accordance with a type of the object, at least one of purchase connection information, facility guidance information, evaluation information, component information, related target information, and nearby provision location information; to transmit the display information to the portable information processing apparatus for presentation together with an operation selection unit and an additional request input unit; and, in response to additional input from the user obtained during presentation, to repeatedly execute processing of generating an updated prompt sentence and obtaining updated related information, the updated prompt sentence and the updated related information being conditioned on at least one of the additional input and emotional information indicative of an estimated emotional state of the user. This enables an integrated, adaptive human-machine interaction pipeline in which the server centrally controls prompt-sentence construction, generative AI model invocation, and information post-processing based on object recognition results, structured base data, user-selected operations, and emotion feedback, thereby improving computational efficiency, reducing unnecessary data transfer, and producing context-aware, emotion-aware information outputs that are technically better aligned with the capabilities of the underlying computing resources.

The term “system” refers to an arrangement of one or more information processing apparatuses, storage apparatuses, and input/output apparatuses that cooperate via hardware and software to execute the functions recited in the claims.

The term “processor” refers to one or more hardware processing units, such as a central processing unit, a graphics processing unit, or a dedicated logic circuit, configured to execute instructions and perform arithmetic and logical operations to implement the claimed functions.

The term “portable information processing apparatus” refers to an information processing device that can be carried by a user, including but not limited to a handheld terminal, a mobile terminal, a tablet terminal, a wearable terminal, or a similar computing device having a communication function and a display function.

The term “imaging unit” refers to a hardware component configured to capture optical information of a scene and output image data, such as a camera module, an image sensor, or an equivalent image capturing device.

The term “image data” refers to digital data representing a still image or a frame of a moving image acquired by the imaging unit, including data in any suitable format that can be processed by image processing algorithms.

The term “image processing algorithm” refers to a sequence of computational operations applied to image data, such as resizing, normalization, noise reduction, cropping, feature extraction, or other transformations used to prepare data for subsequent recognition or analysis.

The term “object recognition algorithm” refers to a computational procedure that analyzes image data to identify or classify objects included in the image, such as a pattern recognition algorithm, a machine learning model, or a neural network configured for object detection or classification.

The term “object” refers to a physical or visual target captured in the image data, including but not limited to a product, a facility, a place, or any other visually identifiable entity.

The term “classification information” refers to information indicating a category or type of an object, such as a label, a class identifier, or a category code obtained by the object recognition algorithm.

The term “attribute information” refers to additional information associated with an object beyond its category, such as brand, function, appearance, detected text, identifiers, or other descriptive properties derived from the image data or associated records.

The term “information storage device” refers to any hardware apparatus or logical storage subsystem configured to store data, such as a memory device, a database system, or a storage server.

The term “structured data” refers to data stored in a machine-readable, organized format, such as records, tables, key-value pairs, or documents with defined fields, which can be retrieved and processed by queries or program logic.

The term “basic information” refers to structured information retrieved from the information storage device relating to a recognized object, such as product information, facility information, evaluation information, or related records that form a basis for further processing.

The term “operation content” refers to information indicating an action or function selected or requested by a user in relation to an object, such as a request for details, reviews, comparison, alternative suggestions, simplified explanations, or special offers.

The term “prompt sentence” refers to a text string expressed in natural language that specifies information provision content or processing instructions for a generative information processing model, and that is constructed based on at least the classification information, the attribute information, the basic information, or the operation content.

The term “generative information processing model” refers to a computational model that receives a prompt sentence and optionally additional context as input and generates new information as output, such as a generative AI model for natural language generation or content generation.

The term “related information” refers to output information generated by the generative information processing model based on a prompt sentence, including but not limited to explanation information, summary information, recommendation information, or other descriptive or advisory content concerning an object.

The term “explanation information” refers to natural-language information that describes characteristics, functions, usage, or other descriptive aspects of an object in a more detailed or user-friendly manner than the underlying structured data alone.

The term “summary information” refers to information that condenses and highlights important points related to an object, such as key features, advantages, disadvantages, or user opinions, in a concise form.

The term “recommendation information” refers to information that suggests particular actions, items, or options related to an object, such as recommended products, alternative products, related facilities, or recommended usage methods.

The term “display information” refers to information that is formatted or organized for presentation on a display unit of a terminal or a wearable display apparatus, and that may include text, images, icons, links, or selectable elements.

The term “purchase connection information” refers to information that enables a user to access a purchase or order function for an object, such as a network address, a selectable link, or other data for accessing a transaction interface.

The term “facility guidance information” refers to information relating to a facility, such as location, services, access route, operation hours, or reservation availability, that is suitable for guiding a user.

The term “evaluation information” refers to information representing assessments or opinions about an object, such as numerical ratings, review summaries, or feedback indicators derived from multiple evaluators or sources.

The term “component information” refers to information describing constituent elements of an object, such as ingredients, materials, parts, or other compositional data.

The term “related target information” refers to information regarding other objects associated with the recognized object, such as complementary products, alternative products, related facilities, or similar items.

The term “nearby provision location information” refers to information indicating physical locations at which an object or a related service is available, such as addresses, maps, or identifiers of nearby facilities, based on user location.

The term “display unit” refers to a component configured to visually present information to a user, such as a display panel, a screen, or any visual output device integrated into a terminal.

The term “wearable display apparatus” refers to a display device configured to be worn by a user, such as a head-mounted display, smart glasses, or similar wearable visual interface.

The term “operation selection unit” refers to a user interface element or mechanism that enables a user to select an operation content, including graphical buttons, menu items, gaze-selectable targets, or voice-driven commands.

The term “additional request input unit” refers to a user interface element or mechanism through which a user can provide follow-up input or requests during presentation of display information, such as a text input field, a microphone interface, or an additional command interface.

The term “facial expression data” refers to image data or extracted features representing a user's facial state, obtained by the imaging unit and usable for estimating an emotional state.

The term “voice data” refers to audio data representing a user's speech or non-verbal vocal sounds, captured by a voice input unit and usable for analysis or emotion estimation.

The term “emotion estimation algorithm” refers to a computational procedure that processes facial expression data, voice data, or other user-related signals to estimate an emotional state, such as joy, surprise, interest, or dissatisfaction.

The term “emotional information” refers to information representing an estimated emotional state of a user, which can be associated with prompt generation, operation selection, or information adjustment.

The term “target” refers to an object or region that is selected by the user as a focus of processing or information provision, and that may correspond to a portion of an image, a displayed item, or an identified object.

The term “pointing operation” refers to an operation in which a user indicates a target on a display by a manual input, such as a touch input, a cursor operation, or a similar direct selection action.

The term “gaze detection operation” refers to an operation in which a system detects a user's line of sight or gaze direction to determine a target or select an operation based on visual attention.

The term “voice instruction operation” refers to an operation in which a user issues an instruction by voice, and the system interprets the instruction by speech recognition and natural language understanding.

The term “comparison information” refers to information that comparatively presents characteristics of two or more objects, such as differences in specification, price, rating, or other attributes.

The term “alternative target” refers to an object suggested in place of a currently selected object, such as an alternative product or facility with different characteristics or advantages.

The term “simplified explanation” refers to explanation information that is generated with reduced technical complexity or reduced amount of detail so as to be easily understandable by a user having limited background knowledge.

The term “benefit information” refers to information highlighting advantages, benefits, discounts, special offers, or other favorable aspects associated with an object or a related action.

In one embodiment, a system comprises a server and a terminal that cooperate via a communication network. The terminal is implemented as a portable information processing apparatus, such as a handheld terminal, a mobile terminal, a tablet terminal, or a wearable terminal. The server is implemented as a network-connected information processing apparatus including at least one processor, a memory, and an information storage device such as a relational database, a key-value store, or a document store.

The terminal includes an imaging unit such as a camera module, a voice input unit such as a microphone, a display unit such as a liquid crystal display or an organic light-emitting diode display, and optionally a wearable display apparatus such as smart glasses. The terminal further includes a local memory and executes a terminal-side program, which may be implemented using an operating system-specific framework such as a mobile operating system application framework. The terminal-side program includes modules for camera control, image preprocessing, user interface rendering, local feature extraction, and emotion feature extraction.

The server includes a server-side program executed by the processor. The server-side program includes an image recognition module, a prompt construction module, a generative AI interface module, an emotion integration module, and a response composition module. The server also controls access to the information storage device that holds structured data records for objects such as products and facilities. Such structured data can be stored in a relational database such as a SQL-based database or in a cloud database service.

The terminal captures image data of an object through the imaging unit. The terminal converts a raw camera buffer into a standard digital image representation, and applies an image processing algorithm. The terminal can use an image processing library similar to a common open source computer vision library to perform resizing, normalization, cropping, and denoising. The terminal then either transmits this preprocessed image data to the server or applies a local object recognition algorithm.

In one implementation, the terminal executes a local object recognition algorithm using a compact neural network model deployed in a mobile environment. The model may be a convolutional neural network with multiple convolution, pooling, and fully connected layers, quantized and converted to a mobile inference format. The terminal converts the preprocessed image into a tensor, runs it through the network to produce classification scores, and outputs classification information such as a category label and confidence values, and attribute information such as detected text, barcode identifiers, or visual attributes (for example, color, shape features).

In another implementation, the server receives the preprocessed image from the terminal and executes an object recognition algorithm using a larger neural network model, such as a deep convolutional neural network or a hybrid vision transformer model. The server can run such a model on a graphics processing unit for higher throughput. The server extracts feature maps, applies convolution and attention operations, and computes classification probabilities and object attributes. The server can also run an optical character recognition sub-model or a barcode decoding procedure to obtain additional attribute information. The server thus outputs classification information and attribute information with higher accuracy than a simple rule-based algorithm.

The server retrieves basic information about the recognized object from the information storage device. The server performs a query against a structured schema, for example, a product table including fields such as object identifier, category, textual description, ingredient list, component list, rating scores, price information, and related object identifiers, or a facility table including fields such as facility type, location coordinates, service descriptions, and reservation URLs. The server converts the query result into an intermediate structured representation, for example, an object record that associates classification information and attribute information with the corresponding database entry.

The server generates a prompt sentence in natural language using the prompt construction module. The server uses a deterministic algorithm that combines fixed templates with fields taken from classification information, attribute information, and basic information, as well as operation content selected by the user. For example, the server may map a user-selected operation “details” to a template such as:

“Explain the detailed information of the product ‘[product name]’, including main components, price range, and a concise summary of user evaluations.”

The server replaces “[product name]” by the name field from the object record and inserts context such as category and ratings when constructing the final prompt sentence. Other examples of prompt sentences include:

“Summarize the main positive and negative points from user evaluations of this product, using bullet points that are easy to read on a portable screen.” “Provide a concise description of this facility, including service type, typical usage fee, atmosphere, and whether advance reservation is recommended.”

“The user appears pleased with this product. Generate a short promotional message and propose one limited-time benefit related to this product.”

“The user seems confused by the previous explanation. Re-explain the key features of this product in simple language, and mention only two main advantages and two main drawbacks.”

“The user is losing interest in the current item. Suggest two alternative products in the same category that are cheaper or better rated, and explain briefly why each might be suitable.” These prompt sentences are not manually typed by the user, but are generated programmatically by the server based on structured records and defined templates. This processing differs from human work because the server applies rule-based token insertion and context selection logic to ensure that every prompt sentence carries machine-verifiable identifiers and constraints. For example, the server embeds non-visible tags or identifiers into the prompt, so that the downstream generative AI model output can be related back to original database entries. This integration improves traceability and allows automated validation.

The server inputs the prompt sentence and at least a subset of the basic information into a generative AI model through the generative AI interface module. In one embodiment, the generative AI model is a pre-trained transformer-based language model hosted on a remote computation service. The server constructs an input sequence that concatenates the prompt sentence with structured context, formats the sequence as tokens, and transmits it to the generative AI model via a network API. The generative AI model executes multiple layers of self-attention, feed-forward transformations, and normalization operations to produce an output token sequence, which the server decodes into a natural-language text representing related information such as an explanation, a summary, or recommendations.

In another embodiment, the terminal executes a smaller generative AI model that runs locally. The terminal loads a quantized transformer model from local storage into memory and feeds the prompt sentence into the model. The terminal uses a greedy or beam search decoding algorithm to generate a textual response. The local inference reduces network traffic and response latency for frequently requested, relatively simple outputs.

The server integrates the related information produced by the generative AI model with the basic information to generate display information. The server segmentizes the generative text into sections, associates each section with relevant structured fields (for example, associating a “price” clause with a price field), and constructs a display data structure that includes text sections, icons, and actionable links. The server can select which fields to include depending on the type of object. For a product, the server may include purchase connection information, component information, evaluation information, related target information, and nearby provision location information. For a facility, the server may include facility guidance information, evaluation information, and reservation connection information.

The terminal receives the display information and renders it on the display unit or the wearable display apparatus. The terminal uses a user interface framework to layout text, images, and buttons. The terminal presents an operation selection unit (for example, buttons such as “Details”, “Reviews”, “Compare”, “Alternatives”, “Benefits”) and an additional request input unit (for example, a text field or a microphone icon for voice input). The user operates these units by touch, gaze, or voice. The terminal forwards the selected operation and any additional request to the server, which generates updated prompt sentences and related information as described above.

The terminal also acquires facial expression data and voice data of the user using the imaging unit and the voice input unit while the display information is presented. The terminal extracts facial landmarks and voice features locally using feature extraction algorithms. The terminal can use a lightweight convolutional network for facial expression classification, which takes as input a normalized grayscale facial image and outputs probabilities across emotion categories such as joy, surprise, neutral, and dissatisfaction. For voice, the terminal can compute mel-frequency cepstral coefficients and feed them into a small recurrent or convolutional model to detect affective cues such as excitement or annoyance.

The server or the terminal executes an emotion estimation algorithm that receives the facial and voice features and outputs emotional information representing the estimated emotional state. The server associates this emotional information with the current object and operation context. The server then modifies subsequent prompt sentences by appending explicit descriptors of the emotional information or by selecting different templates. For example, when the emotional information indicates joy, the server may add:

“The user is very satisfied with this product. Provide an additional, concise recommendation emphasizing appropriate add-on products.”

When the emotional information indicates confusion, the server may replace technical terminology in the template with simpler wording and reduce the number of detailed fields. When the emotional information indicates loss of interest, the server may switch to a template that asks for alternative products or a different price range.

This emotion-aware modification changes the behavior of the generative AI model in a structured, rule-driven way that is not equivalent to mere human editing, because it systematically maps internal emotional states to concrete parameterizations of the model input. In addition, the server logs emotional information as structured metadata, which allows the system to learn or tune thresholds and selection rules over time to improve recommendation relevance and reduce unnecessary server calls.

The server improves computational efficiency and communication performance by controlling the timing and contents of generative AI model invocations. Because the server holds both the structured database and the generative AI interface, the server filters and compresses input context before calling the model, and it truncates or restructures the model output to match internal data structures. This reduces the need to transmit large unstructured texts between the server and the terminal, thereby lowering network load. The server can also cache previous results indexed by combinations of classification information, attribute information, operation content, and emotional information. When the same or similar combination occurs, the server can reuse cached related information instead of re-invoking the generative AI model, thus improving response time.

The described architecture provides a technical improvement over conventional systems in several respects. First, the joint use of a deterministic prompt construction module and a generative AI interface allows the server to constrain and guide the generative AI model, reducing irrelevant content and improving factual consistency with the structured database. Second, the emotion integration module and the associated data structures connect sensor-level features (facial and vocal signals) to high-level generation control, enabling the server to avoid unnecessary or undesired generations and reduce redundant back-and-forth interactions. Third, by distributing processing between a resource-limited terminal and a more powerful server, and by using quantized models on the terminal and larger models on the server, the system optimizes computation based on device capabilities, resulting in improved processing speed and reduced energy consumption.

In one variant, the terminal performs more extensive on-device processing. The terminal uses a local convolutional neural network for object recognition and maintains a local cache of object records for frequently encountered products. The terminal generates a first-stage prompt sentence and runs a local generative model to produce a short explanation. When the user requests deeper information or comparison, the terminal forwards additional context to the server, which uses a larger generative AI model and more detailed database queries. This multi-stage architecture reduces average bandwidth usage and server load, because trivial or repetitive queries are handled locally.

In another variant, the server performs nearly all recognition and generation tasks, and the terminal primarily handles sensor capture and user interface. Even in this case, the server maintains a modular pipeline: image recognition module outputs standardized classification and attribute information; prompt construction module maps these to prompt templates; generative AI interface module negotiates input and output with the generative AI model; emotion integration module modifies prompts based on emotional information; response composition module correlates model output back to structured fields and constructs display information. The explicit separation of these modules and their data interfaces provides a well-defined technical architecture that can be implemented, scaled, and optimized independently.

The system is not limited to a particular type of neural network architecture. The object recognition algorithm can be implemented using convolutional networks, residual networks, or attention-based vision models. The generative AI model can be implemented using encoder-decoder transformers, decoder-only transformers, or other sequence models. Training of these models can be performed offline using large datasets of labeled images and text.

During training, the system can use standard loss functions such as cross-entropy for classification and language modeling, and can employ gradient-based weight updates such as stochastic gradient descent with momentum or adaptive methods. Data augmentation techniques such as random cropping, rotation, and color jitter can improve robustness of recognition. Hyperparameters such as learning rate, batch size, and network depth can be tuned to balance accuracy and computation.

Because the server and the terminal implement the above-described data structures, algorithms, and communication flows, the system performs more than a mere automation of human cognitive tasks. The server executes non-conventional combinations of image processing, database querying, prompt construction, emotion-aware generation control, and display composition that are specifically adapted to the capabilities and constraints of computing hardware. This leads to measurable technical effects such as improved recognition accuracy through multi-stage recognition, reduced latency through caching and local inference, reduced network traffic through compressed and structured communication, and lower error rates in user-visible recommendations through emotion-aware prompt control. As a result, the system improves the functioning of the computer network itself as an information processing platform, rather than simply implementing a business method or human workflow on a generic computer.

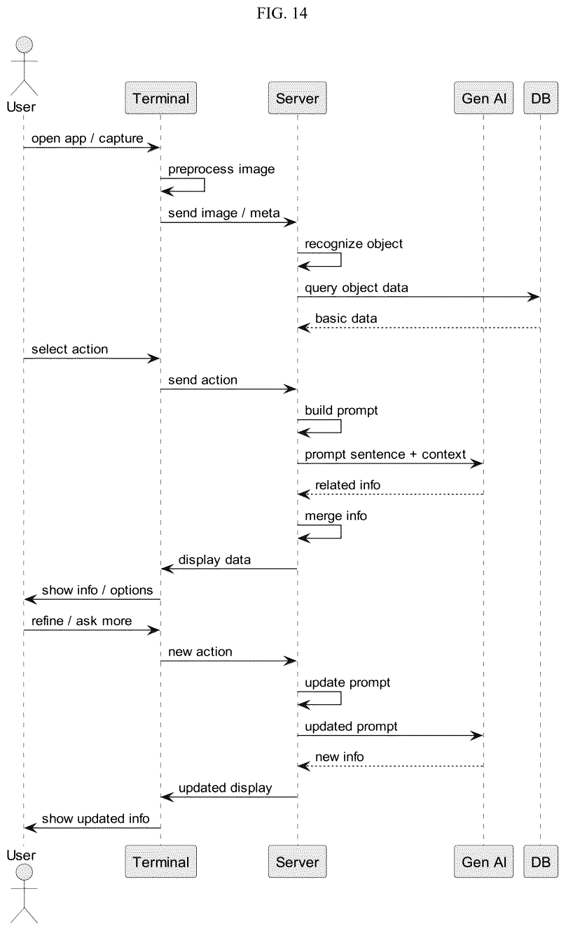

The following describes the processing flow using FIG. 14.

### Step 1:

User activates the application on the terminal and captures an object.

The user starts a dedicated application on the terminal and directs the terminal's imaging unit toward a physical object, such as a product package or a facility sign. The user presses a capture button or performs a gesture to trigger image capture.

Input: a real-world scene including at least one object.

Output: raw image data (for example, a YUV or RGB frame) stored in the terminal's memory.

The terminal controls the camera hardware via an operating system API, receives the sensor buffer, and converts the data into a standard in-memory image representation.

### Step 2:

Terminal pre-processes the captured image.

The terminal applies an image processing algorithm to the raw image data in order to prepare it for recognition.

Input: raw image data from Step 1.

Output: preprocessed image data (for example, a resized and normalized RGB array) suitable for model input.

The terminal uses an image processing library to perform operations such as resizing to a fixed resolution, converting color space, cropping central regions, and normalizing pixel values. These operations constitute data transformations that reduce noise and adapt the image to a fixed input tensor format for subsequent object recognition.

### Step 3:

Terminal or server performs object recognition and extracts classification and attribute information.

The terminal either runs a local object recognition model or sends the preprocessed image to the server for recognition.

Input: preprocessed image data from Step 2.

Output: classification information (for example, object category label and confidence) and attribute information (for example, detected text, barcode ID, color, shape features).

If the terminal performs recognition, the terminal converts the image into a tensor and feeds it into a convolutional neural network; the network performs convolution, pooling, and fully connected operations, and the terminal reads the output layer to identify the category and attributes. If the server performs recognition, the terminal transmits the preprocessed image via a network protocol; the server receives the data, runs a larger neural network on a processing unit, and returns the classification and attribute information to the terminal.

### Step 4:

Server retrieves basic information from a structured data store.

The server receives classification information and attribute information and queries an information storage device to obtain structured records related to the recognized object.

Input: classification information and attribute information from Step 3.

Output: basic information record including fields such as object name, category, structured description, components, ratings, prices, facility data, and related object identifiers.

The server executes database queries using the object category and identifiers as keys, performs index lookups, joins related tables if necessary, and constructs an in-memory object record that aggregates all relevant fields.

### Step 5:

Server determines user operation content and context.

The server receives the current user-selected operation from the terminal and associates it with the recognized object.

Input: basic information from Step 4 and operation content (for example, “details”, “reviews”, “compare”, “alternatives”, “benefits”) received from the terminal.

Output: a combination of object context and operation context used to control prompt construction.

The server inspects the operation content, maps it to an internal operation type, and binds this type to the object record. The server stores this combination as a context structure that will drive the selection of a prompt template and the fields to be included in the prompt sentence.

### Step 6:

Server constructs a prompt sentence for a generative AI model.

The server uses the context structure to generate a natural-language prompt sentence that specifies the information provision content.

Input: classification information, attribute information, basic information, and operation content from Step 5.

Output: a prompt sentence expressed in natural language.

The server selects a template based on the operation content, inserts parameters such as object name, category, key components, ratings, and user intention, and concatenates them into a complete text string. For example, when the operation content is “details”, the server generates a prompt sentence such as:

“Explain the detailed information of the product ‘[product name]’, including main components, price range, and a concise summary of user evaluations.”

This processing includes data formatting, string concatenation, and template rule application to transform structured fields into a coherent natural-language instruction.

### Step 7:

Server sends the prompt sentence and context to a generative AI model and obtains related information.

The server invokes a generative AI model through a network or local interface and passes the constructed prompt sentence and relevant structured context.

Input: prompt sentence from Step 6 and at least a subset of the basic information.

Output: related information generated by the generative AI model, such as explanation information, summary information, or recommendation information.

The server tokenizes the prompt sentence, embeds tokens using the model's vocabulary, and sends the token sequence to the generative AI model. The model performs multiple layers of self-attention and feed-forward computation to generate an output token sequence, which the server decodes back into text. The server thus transforms structured context and an operation type into rich, human-readable related information.

### Step 8:

Server integrates related information with basic information and composes display information.

The server merges the generative AI output with the existing structured data to prepare information suitable for rendering on the terminal.

Input: related information from Step 7 and basic information from Step 4.

Output: display information including text sections, structured fields, and actionable elements such as links and buttons.

The server parses the generative text into sections (for example, overview, pros, cons), tags each section with related database fields, and selects which items to include based on the object type. For a product, the server adds purchase connection information, component information, evaluation information, and nearby provision location information; for a facility, the server adds facility guidance information and reservation connection information. The server structures this as a display data object ready for transmission.

### Step 9:

Server transmits display information to the terminal.

The server sends the composed display information to the terminal over the network.

Input: display information from Step 8.

Output: a network response containing display data received by the terminal.

The server serializes the display information into a transfer format, attaches identifiers and timestamps, and transmits the serialized data through a network protocol. The terminal receives the data and decodes it into an internal representation for user interface rendering.

### Step 10:

Terminal renders display information and presents operation selection and additional request input.

The terminal displays the information received from the server on the display unit or the wearable display apparatus and provides interactive controls.

Input: display information from Step 9.

Output: a rendered user interface containing object information, operation selection elements, and additional request input elements.

The terminal lays out text, images, and icons using a user interface framework, creates buttons or selectable items for operations such as “Details”, “Reviews”, “Compare”, “Alternatives”, and “Benefits”, and displays a text field or voice input control for additional user requests. The rendering transforms the display data structure into screen pixels and interactive elements that the user can see and manipulate.

### Step 11:

Terminal acquires user additional input and forwards it to the server.

The user interacts with the rendered interface by selecting operations or entering further requests.

Input: user actions on the operation selection unit and additional request input unit.

Output: updated operation content and optional free-form request text or voice transcription sent to the server.

The terminal detects touch events, gaze selections, or voice commands, converts voice into text via a speech recognition module, and constructs an input message that includes the selected operation, user text, and reference to the current object context. The terminal sends this message to the server as a new request to adjust or refine the information.

### Step 12:

Terminal collects facial and voice features and performs emotion feature extraction.

The terminal uses its imaging unit and voice input unit to capture the user's facial expression and voice characteristics during the interaction.

Input: sensor data including facial images and voice samples captured while the user views the display information.

Output: emotion-related feature vectors representing facial and vocal cues.

The terminal runs a feature extraction algorithm on the captured images to detect facial landmarks and normalize them, and computes audio features such as spectral coefficients. These operations convert raw sensor signals into compact numerical representations that describe the user's current affective state.

### Step 13:

Server or terminal estimates user emotion state and generates emotional information.

The server or the terminal applies an emotion estimation algorithm to the extracted features in order to determine an emotion category.

Input: emotion-related feature vectors from Step 12.

Output: emotional information indicating an estimated emotional state, such as joy, confusion, or loss of interest.

The server or terminal feeds the feature vectors into an emotion classification model, which computes a probability distribution over emotion categories, selects the highest-probability category, and outputs this as emotional information. This constitutes a data computation step that maps multidimensional feature vectors to a discrete emotional label.

### Step 14:

Server modifies prompt construction based on additional user input and emotional information.

The server receives the updated user operations and the emotional information, and adjusts the prompt construction strategy accordingly.

Input: additional operation content from Step 11 and emotional information from Step 13, together with the object context and basic information from prior steps.

Output: an updated prompt sentence that reflects both the user's explicit request and the implicit emotional state.

The server selects a new prompt template according to the new operation content and modifies or extends the template based on the emotional information. For example, if the emotional information indicates confusion, the server chooses a template focused on simplified explanations; if the emotional information indicates joy, the server adds a clause requesting benefit information or add-on recommendations. The server then regenerates the prompt sentence by inserting object data into this modified template.

### Step 15:

Server re-invokes the generative AI model using the updated prompt sentence and produces new related information.

The server calls the generative AI model again with the updated prompt sentence and context to obtain refined or additional information.

Input: updated prompt sentence from Step 14 and existing basic information.

Output: new related information, such as a simplified explanation, alternative recommendations, or benefit-oriented content.

The server repeats the tokenization, embedding, and model inference process, but the changed prompt content and emotional cues cause the generative AI model to produce a different text output that better matches the user's needs and state.

### Step 16:

Server recomposes and retransmits updated display information, and terminal updates the user interface.

The server integrates the new related information with the existing basic information and constructs updated display information, which it sends to the terminal; the terminal then refreshes the displayed content.

Input: new related information from Step 15 and the original basic information from Step 4.

Output: updated display information on the terminal, including newly generated text, revised recommendations, and possibly changed emphasis (for example, simplified sections or highlighted benefits).

The server updates the display data structure by replacing or appending sections, adjusts which buttons or links are emphasized based on the new operation content, and sends this updated structure to the terminal. The terminal receives the update, re-renders the interface, and shows the refined explanation, comparison, alternatives, or offers to the user, thereby closing one cycle of adaptive, emotion-aware interaction driven by prompt sentences and a generative AI model.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### SECOND EXEMPLARY EMBODIMENT

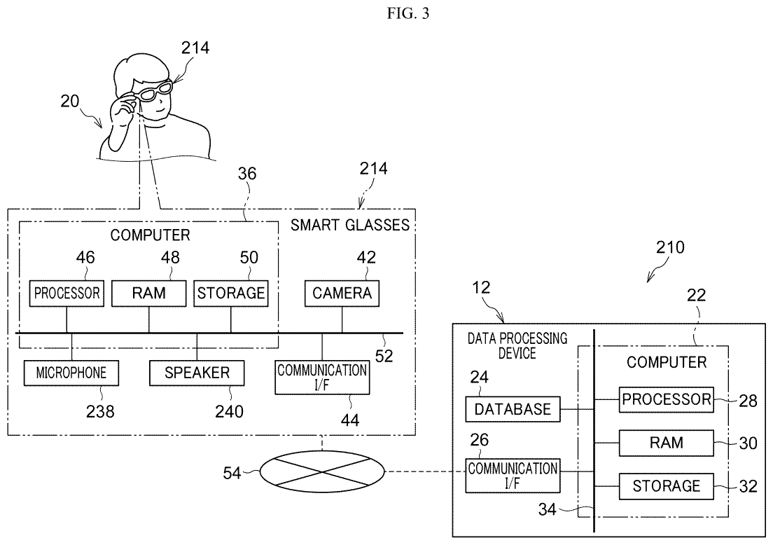

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

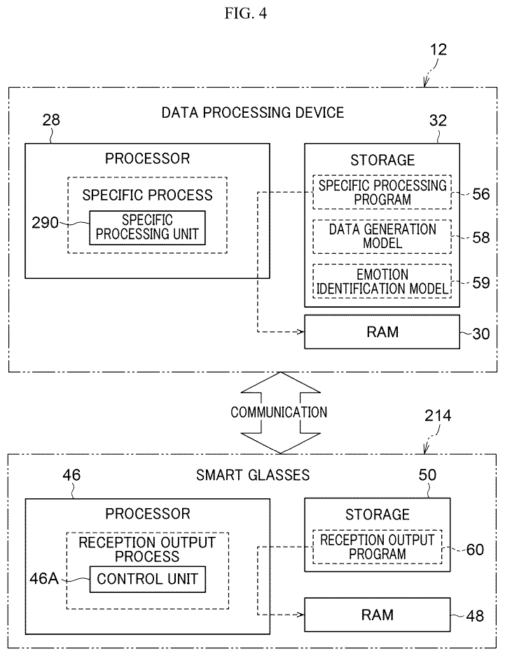

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples.

Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### THIRD EXEMPLARY EMBODIMENT

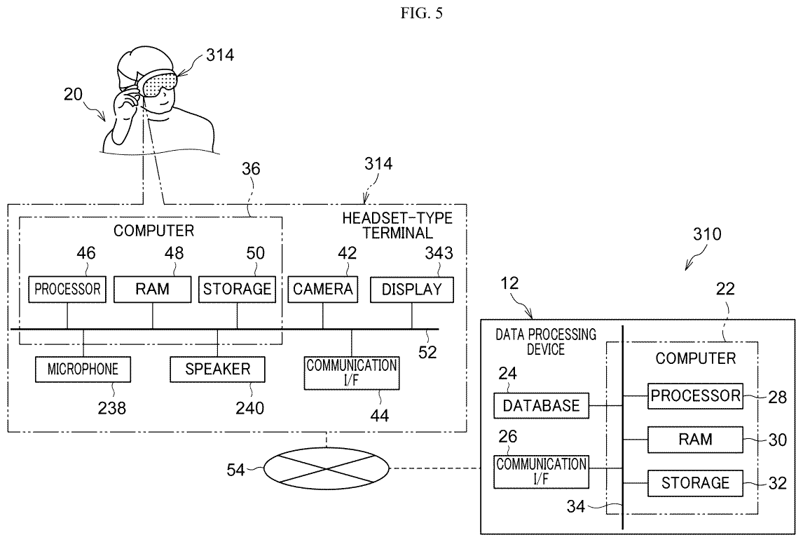

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

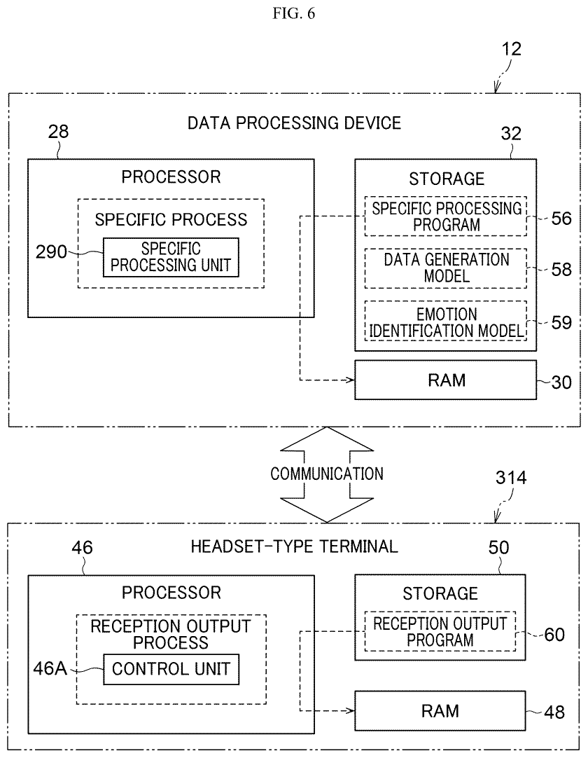

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### FOURTH EXEMPLARY EMBODIMENT

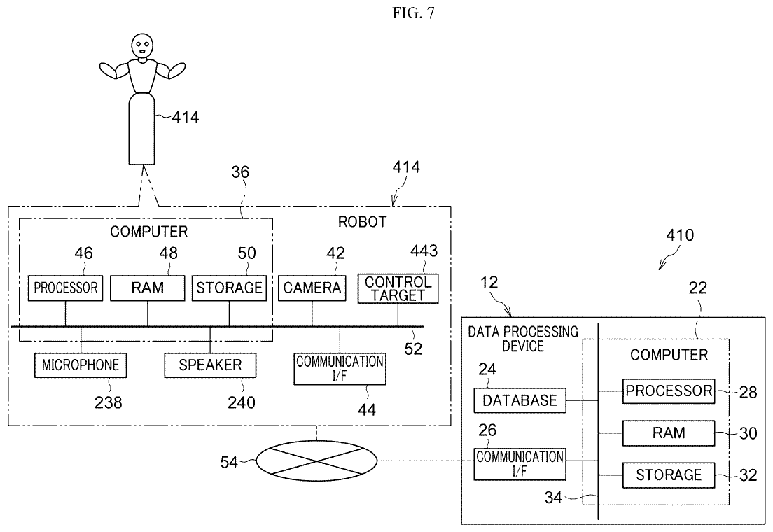

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

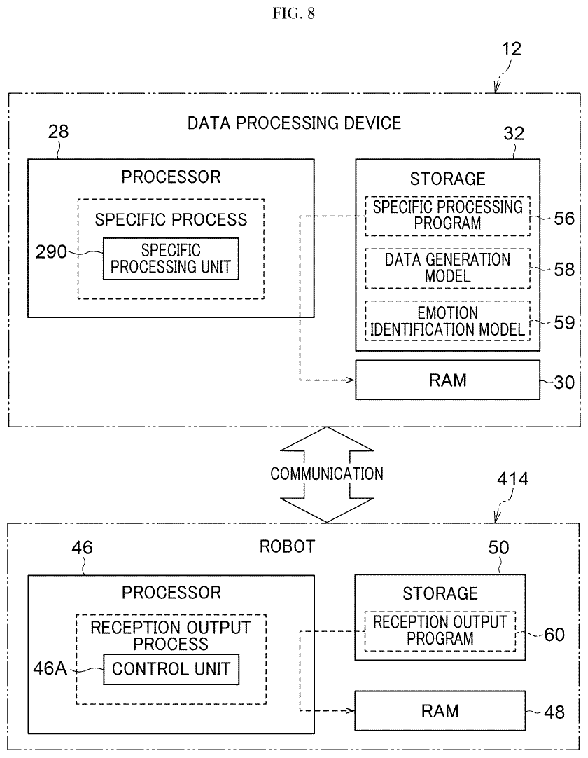

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

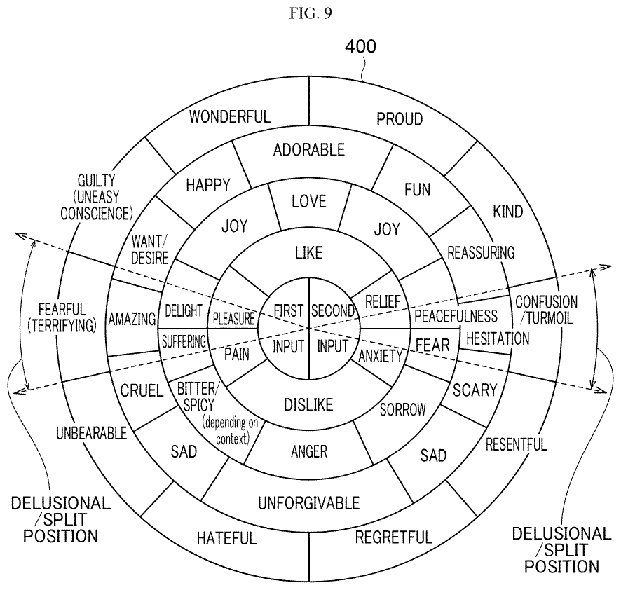

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

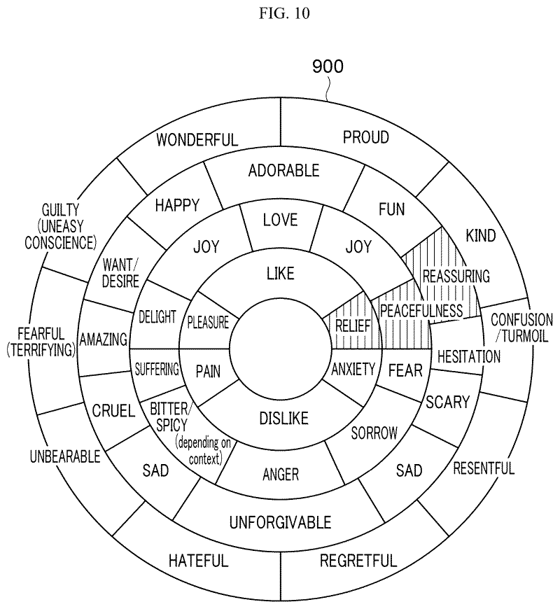

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor, wherein the processor is configured to capture an image of a target object by using an imaging unit of a portable information processing device, and analyze acquired image data by an object recognition algorithm and an image feature extraction algorithm to identify the target object in the image and feature information corresponding to the target object, and acquire candidate information and candidate actions to be presented for the target object on the basis of the feature information and a category of the target object, generate structured data including the candidate information and the candidate actions, and further generate a prompt sentence describing an analysis result including the structured data, and transmit the prompt sentence and the structured data to a remote information processing device so as to input the prompt sentence and the structured data to a generative AI model operating on the remote information processing device, and cause the generative AI model to generate response data including information related to the target object and including one or more actions selected from among the candidate actions, on the basis of the prompt sentence and the structured data, and receive the response data output from the generative AI model, transmit information included in the response data to the portable information processing device, and cause the portable information processing device to output the information as display data, and cause the portable information processing device to display, on a user interface, an operation component corresponding to the one or more actions included in the response data, and in response to a selection operation by a user, execute communication processing for accessing an external service or an information resource corresponding to the selected action, and store log data including the response data, the category of the target object, and a selection result by the user, and update wording of the prompt sentence or a retrieval condition for the candidate information on the basis of the log data.

### (Supplementary 2)

The system according to supplementary 1,
wherein the processor is configured to
acquire facial information or voice information of a user, execute emotion analysis processing on the facial information or the voice information to estimate an emotional state, and attach the emotional state to the prompt sentence or the structured data so as to optimize content of the information generated by the generative AI model.

### (Supplementary 3)

The system according to supplementary 1,
wherein the processor is configured to
receive a designation operation by the user via a user interface so as to manually select the target object from a region in the image data, generate the structured data including feature information and candidate actions corresponding to the selected target object, and generate the prompt sentence for instructing an action regarding the selected target object on the basis of the structured data.

### Application Example 1

### (Supplementary 1)

A system comprising a processor,
wherein the processor is configured to
capture, by a portable information processing apparatus including an imaging unit, an image of a target and generate image data of the captured image,
perform image recognition processing on the image data to determine whether the target is a merchandise item, and, when the target is determined to be the merchandise item, generate target information including a merchandise category, a merchandise attribute, and identification information,
construct, on the basis of the target information, a prompt sentence to be input to a generative information processing model, and control information items and an expression style included in the prompt sentence so as to define an inquiry content capable of acquiring at least one of a merchandise description, evaluation information, price information, inventory information, and sales promotion information,
transmit the prompt sentence via a network to an information processing apparatus, and cause the generative information processing model operating on the information processing apparatus to generate related information in a natural language with respect to the merchandise item based on the prompt sentence,
associate the related information output from the generative information processing model with structured data stored in at least one of a merchandise information storage unit, an inventory information storage unit, and a sales promotion information storage unit, and generate integrated information by supplementing or correcting the related information with the structured data, and
transmit the integrated information to the portable information processing apparatus, and cause the portable information processing apparatus to display the integrated information on a screen as at least one of a merchandise description, an evaluation summary, a price comparison, an inventory status, and sales promotion content, thereby providing information for a purchase decision in a physical store.

### (Supplementary 2)

The system according to supplementary 1,
wherein the processor is configured to
acquire expression information or voice information of a user by the portable information processing apparatus, perform emotion analysis processing on the expression information or the voice information, and change at least one of a presentation content, a presentation order, and a level of detail of the integrated information according to an analysis result of the emotion analysis processing.

### (Supplementary 3)

The system according to supplementary 1,
wherein the processor is configured to
receive a selection operation for a target region in the captured image from the user via the portable information processing apparatus, generate the prompt sentence based on target information corresponding to the selected target region, and dynamically switch an inquiry content for the generative information processing model for each target according to the selection operation.

### Example 2

### (Supplementary 1)

A system comprising a processor and a memory,
wherein the processor is configured to
cause a communication unit to transmit, to a terminal device, screen interface data including markup information and script information, the screen interface data being configured to display, on a display unit of the terminal device, a visual interface for allowing a user to manually select an operation target and to detect a user operation on the operation target,
receive, from the terminal device, identification information for the operation target that has been manually selected by the user,
acquire, from the memory, target-related information stored in association with the identification information for the operation target,
generate a prompt sentence based on the target-related information and application context information, the prompt sentence being configured to cause a generative artificial intelligence model to design one or more operations executable by the user with respect to the operation target,
output the prompt sentence to the generative artificial intelligence model and obtain response information related to the one or more operations,
structure operation candidates included in the response information as operation information including internal operation codes and display labels,
combine the operation information with the target-related information to generate operation presentation data,
transmit the operation presentation data to the terminal device so that the terminal device displays, on the display unit, a dynamic screen including detail information of the operation target and the operation candidates,
receive, from the terminal device, operation identification information identifying an operation candidate selected by the user, and
execute, based on the operation identification information and information associated with the operation target, at least one of a transaction process and an information provision process, and cause a result of the process to be transmitted to the terminal device.

### (Supplementary 2)

The system according to supplementary 1,
wherein the processor is configured to
acquire operation history information of the user and environment information, and
include at least part of the operation history information and the environment information in the prompt sentence so that the generative artificial intelligence model dynamically changes the operation candidates to be suitable for the user.

### (Supplementary 3)

The system according to supplementary 1,
wherein the processor is configured to
cause a script program executed on the terminal device to monitor input operation events on screen elements displayed on the display unit,
cause the script program to generate, based on the input operation events, identification information for the operation target and identification information for an operation candidate, and transmit the identification information for the operation target and the identification information for the operation candidate to the system, and
trigger, based on the transmitted identification information for the operation target and the identification information for the operation candidate, generation of the operation candidates by the generative artificial intelligence model and execution of a process corresponding to the selected operation candidate.

### Application Example 2

### (Supplementary 1)

A system comprising a processor,
wherein the processor is configured to
capture an object by using an imaging unit of a portable information processing apparatus, and apply an image processing algorithm and an object recognition algorithm to acquired image data to identify classification information and attribute information of the object, and acquire basic information related to the object by searching structured data stored in an information storage device based on the classification information and the attribute information, and generate a prompt sentence that defines, in natural language, information provision content to be executed for the object, in accordance with the basic information and an operation content selected by a user, and
input the prompt sentence and the basic information to a generative AI model operating on an information processing apparatus connected via a network, and cause the generative AI model to generate related information including explanation information, summary information, or recommendation information concerning the object, based on the prompt sentence, and
integrate the related information with the basic information, construct display information including, according to a type of the object, purchase connection information, facility guidance information, evaluation information, component information, related target information, or nearby provision location information, and transmit the display information to the portable information processing apparatus, and
cause a display unit of the portable information processing apparatus or a wearable display apparatus to present the display information together with an operation selection unit and an additional request input unit to the user, and repeatedly execute generation processing of the prompt sentence and the related information in response to additional input from the user obtained during the presentation.

### (Supplementary 2)

The system according to supplementary 1,
wherein the processor is configured to
acquire facial expression data and voice data of the user by using the imaging unit and a voice input unit, estimate an emotional state by an emotion estimation algorithm, and adjust content,
level of detail, or recommendation targets of the related information and the display information dynamically by adding emotional information indicating the emotional state to the prompt sentence or reflecting the emotional state in operation selection.

### (Supplementary 3)

The system according to supplementary 1,
wherein the processor is configured to
select a target based on a pointing operation on a screen region, a gaze detection operation, or a voice instruction operation by the user on the portable information processing apparatus,
acquire a selection result in association with the classification information and the attribute information of the object, and generate the prompt sentence including contents for instructing presentation of comparison information, presentation of alternative targets, presentation of simplified explanation, or presentation of benefit information in accordance with selected operation content.

What is claimed is:

1. A system comprising:
circuitry configured to:
receive, via a packet-switched network, image data captured by an imaging unit of a terminal device;
execute a convolutional neural network on a tensor representation of the image data to extract a feature vector and determine a category label for a target object depicted in the image data;
construct structured data comprising the feature vector, the category label, and candidate action identifiers associated with the target object;
generate a structured prompt for a generative neural network model by selecting a prompt template based on the category label and inserting attribute values derived from the structured data into the prompt template;
transmit the structured prompt to an information processing apparatus hosting the generative neural network model via the packet-switched network, receive a generated output token sequence, and parse the generated output token sequence to extract response data comprising descriptive information and at least one selected action from among the candidate action identifiers;
transmit the response data to the terminal device via the packet-switched network to cause rendering of the descriptive information and an operation component corresponding to the at least one selected action on a display of the terminal device; and
store log data associating the category label, the structured prompt, the response data, and selection result data received from the terminal device indicating a user interaction with the operation component, and update at least one of wording of the prompt template or a retrieval condition for the candidate action identifiers based on the log data.

2. The system according to claim 1, wherein the terminal device applies a lightweight convolutional neural network to the image data to produce preliminary feature information and a preliminary category label, and transmits the image data, the preliminary feature information, and the preliminary category label to the circuitry via the packet-switched network.

3. The system according to claim 2, wherein the circuitry executes a vision backbone model comprising a deep convolutional neural network or a vision transformer on the image data, performs matrix multiplications, non-linear activations, and normalization operations on dedicated processing hardware to produce the feature vector, updated category probabilities, and object bounding box coordinates.

4. The system according to claim 3, wherein the circuitry is further configured to:
crop the image data according to the object bounding box coordinates and apply an optical character recognition engine to the cropped image data to detect text strings, and include the detected text strings in the structured data.

5. The system according to claim 4, wherein the circuitry is further configured to:
compute similarity scores between the feature vector and stored feature vectors in a storage device, apply filtering conditions based on the category label and the detected text strings, and retrieve candidate records corresponding to the target object from the storage device as the candidate action identifiers.

6. The system according to claim 5, wherein the generative neural network model comprises a neural network with attention layers and feed-forward layers, and the circuitry tokenizes the structured prompt into numerical embeddings, feeds the numerical embeddings into the generative neural network model, and decodes output probability distributions over tokens to generate the generated output token sequence.

7. The system according to claim 6, wherein the circuitry is further configured to:
validate the response data by checking whether each selected action matches an action in the structured data, remove or remap inconsistent entries, and attach concrete identifiers comprising database record identifiers and network addresses to each validated action.

8. The system according to claim 7, wherein the target object comprises a merchandise item, and the structured data further comprises a merchandise category, a merchandise attribute, and identification information, and the structured prompt instructs the generative neural network model to generate at least one of a merchandise description, evaluation information, price information, inventory information, or sales promotion information.

9. The system according to claim 8, wherein the circuitry is further configured to:
associate the response data with structured records stored in at least one of a merchandise information storage, an inventory information storage, or a sales promotion information storage, and generate integrated information by supplementing or correcting the response data with the structured records before transmitting to the terminal device.

10. The system according to claim 1, wherein the circuitry is further configured to:
receive facial image data or audio data of a user of the terminal device, execute emotion analysis processing on the facial image data or the audio data to estimate an emotional state of the user, and attach the emotional state to the structured prompt or the structured data to cause the generative neural network model to optimize content of the response data based on the emotional state.

11. The system according to claim 10, wherein the circuitry changes at least one of a presentation content, a presentation order, or a level of detail of the response data according to the estimated emotional state.

12. The system according to claim 1, wherein the circuitry is further configured to:
receive a designation operation from the terminal device indicating a user-selected region in the image data, identify a target object within the user-selected region, and generate the structured data and the structured prompt based on the identified target object within the user-selected region.

13. The system according to claim 1, wherein updating the wording of the prompt template comprises analyzing selection frequencies and performance metrics computed from accumulated log data records and modifying dynamic insertion points or instruction text within the prompt template to improve relevance of future response data.

14. The system according to claim 13, wherein updating the retrieval condition comprises adjusting filtering parameters or similarity score thresholds used to retrieve the candidate action identifiers from the storage device based on correlation between the candidate action identifiers and the selection result data in the accumulated log data records.

15. The system according to claim 1, wherein the terminal device, in response to the user interaction with the operation component, executes communication processing for accessing an external service corresponding to the at least one selected action by transmitting a structured request to a service endpoint via the packet-switched network.

16. The system according to claim 1, wherein the circuitry is further configured to:
transmit partial response data to the terminal device as tokens of the generated output token sequence are produced, enabling the terminal device to begin rendering portions of the descriptive information while remaining tokens are still being generated.

17. The system according to claim 1, wherein the circuitry converts the image data to the tensor representation by resizing the image data to a fixed resolution, normalizing pixel intensity values, and forming a multi-dimensional array of shape corresponding to channels, height, and width.

18. A system comprising:
circuitry configured to:
receive, via a packet-switched network, image data and preliminary feature information from a terminal device, the preliminary feature information produced by a lightweight convolutional neural network executed on the terminal device;
execute a vision backbone model on the image data to extract a refined feature vector, determine a category label and object bounding box coordinates for a target object, and apply an optical character recognition engine to a cropped region of the image data to detect text strings;
construct structured data comprising the refined feature vector, the category label, the object bounding box coordinates, the detected text strings, and candidate action identifiers retrieved from a storage device based on similarity scores between the refined feature vector and stored feature vectors;
generate a structured prompt for a generative neural network model by inserting attribute values from the structured data into a prompt template selected based on the category label, transmit the structured prompt to an information processing apparatus hosting the generative neural network model via the packet-switched network, and receive a generated output token sequence;
parse the generated output token sequence to extract response data comprising descriptive information and at least one selected action, validate the response data against the structured data, and enrich the response data with concrete identifiers;
transmit the response data to the terminal device via the packet-switched network to cause rendering of the descriptive information and an operation component on a display of the terminal device;
receive facial image data or audio data of a user, execute emotion analysis processing to estimate an emotional state, and adjust at least one of content, order, or level of detail of the response data based on the emotional state; and
store log data associating the structured prompt, the response data, and selection result data, and update the prompt template or retrieval conditions based on the log data.

19. The system according to claim 18, wherein the target object comprises a merchandise item, and the structured prompt instructs the generative neural network model to generate at least one of a merchandise description, evaluation information, price information, or inventory information, and the circuitry associates the response data with structured records from at least one of a merchandise information storage or an inventory information storage to generate integrated information.

20. A method performed by circuitry, the method comprising:
receiving, via a packet-switched network, image data captured by an imaging unit of a terminal device;
executing a convolutional neural network on a tensor representation of the image data to extract a feature vector and determine a category label for a target object depicted in the image data;
constructing structured data comprising the feature vector, the category label, and candidate action identifiers associated with the target object;
generating a structured prompt for a generative neural network model by selecting a prompt template based on the category label and inserting attribute values derived from the structured data into the prompt template;
transmitting the structured prompt to an information processing apparatus hosting the generative neural network model via the packet-switched network, receiving a generated output token sequence, and parsing the generated output token sequence to extract response data comprising descriptive information and at least one selected action from among the candidate action identifiers;
transmitting the response data to the terminal device via the packet-switched network to cause rendering of the descriptive information and an operation component corresponding to the at least one selected action on a display of the terminal device; and
storing log data associating the category label, the structured prompt, the response data, and selection result data received from the terminal device, and updating at least one of wording of the prompt template or a retrieval condition for the candidate action identifiers based on the log data.
